(19) United States
(12) Patent Application Publication
(10) Pub. No.: US 2022/0334453 A1
(43) Pub. Date: Oct. 20, 2022

(54) LENS MODULE

(71) Applicant: LG INNOTEK CO., LTD., Seoul (KR)

(72) Inventors: Yun Sang SONG, Seoul (KR); Jung Shik BAIK, Seoul (KR)

(21) Appl. No.: 17/753,969

(22) PCT Filed: Sep. 17, 2020
(86) PCT No.: PCT/KR2020/012589

§ 371 Date: Mar. 18, 2022

(30) Foreign Application Priority Data
Sep. 18, 2019 (KR) 10-2019-0114803

(51) Int. Cl. G03B 13/36; G02B 7/02; G02B 26/00

(52) U.S. Cl. CPC G03B 13/36; G02B 7/021; G02B 26/004

(57) ABSTRACT

A lens module according to an embodiment includes a first lens barrel in which a first solid lens is disposed; a second lens barrel disposed on the first lens barrel; and a variable focus lens disposed in the second lens barrel; wherein at least a part of the first lens barrel is disposed in the second lens barrel, and wherein the at least a part of the first lens barrel includes a region spaced apart from an inner surface of the second lens barrel.

### TECHNICAL FIELD

An embodiment relates to a lens module and a camera device including the same.

### BACKGROUND ART

A user of a portable device desires an optical device having a high resolution, a small size, and various photographing functions (eg, auto-focusing (AF) function, image stabilization or optical image stabilizer (OIS) function, etc.) This photographing function can be implemented through a method of directly moving lenses by combining multiple lenses, but if the number of lenses is increased, the size of the optical device may be increased. The autofocus function and the image stabilization function are performed by moving or tilting a plurality of lens modules fixed to a lens holder and aligned with an optical axis in the optical axis or a vertical direction of the optical axis, and a separate lens driving device is used to drive the lens module. However, the lens drive device consumes high power, and to protect this, a cover glass must be added separately from the camera module, so the overall thickness is increased.

Therefore, research on a liquid lens that performs autofocus and image stabilization functions by electrically controlling a curvature of an interface between two liquids is being conducted.

However, a variable lens such as a conventional liquid lens is manufactured in a separate package type and has a structure coupled to a camera device, and accordingly, there is a problem in that the coupling structure between a solid lens and a liquid lens becomes complicated. In addition, the complexity of the coupling structure as described above not only degrades the assembly of the camera device, but also acts as a factor to increase the size of the overall lens assembly.

### DISCLOSURE

### Technical Problem

A present embodiment provides a lens module in which a variable focus lens and a solid lens are combined into one lens barrel, and a camera device including the same.

In addition, the present embodiment provides a lens module in which a plurality of solid lenses and a variable focus lens are respectively combined by applying two lens barrels, and a camera device including the same.

In addition, the present embodiment provides a lens module in which an electrode pattern for controlling the variable focus lens is implemented on an inner periphery and/or an outer periphery of the lens barrel to which the variable focus lens is coupled, and a camera device including the same.

### Technical Solution

A lens module according to an embodiment includes a first lens barrel in which a first solid lens is disposed; a second lens barrel disposed on the first lens barrel; and a variable focus lens disposed in the second lens barrel; wherein at least a part of the first lens barrel is disposed in the second lens barrel, and wherein the at least a part of the first lens barrel includes a region spaced apart from an inner surface of the second lens barrel.

In addition, the lens module further comprises a second solid lens disposed in the second lens barrel, wherein the variable focus lens is disposed between the first solid lens and the second solid lens.

In addition, the second lens barrel includes a protrusion corresponding to a side surface of the variable focus lens.

In addition, a shape of the variable focus lens viewed in an optical axis direction has a circular shape.

In addition, the protrusion is formed along the side surface of the variable focus lens, and an inner periphery of the protrusion has a circular shape.

In addition, the second lens barrel includes a first region including a first sidewall; and an extension portion extending outwardly from the first sidewall.

In addition, the second lens barrel includes a second region including a second sidewall extending downwardly from the extension portion.

In addition, the first lens barrel includes a first region having a first width and a second region having a second width greater than the first width.

In addition, an outer surface of the first lens barrel has a stepped portion.

In addition, the first sidewall of the second lens barrel overlaps the first region of the first lens barrel in a direction parallel to an optical axis.

In addition, the second lens barrel includes an electrode pattern electrically connected to the variable focus lens.

In addition, the electrode pattern includes electrode lines equal to or greater than a number of electrodes of the variable focus lens.

In addition, at least a part of the electrode pattern is disposed between the protrusion and a lower surface of the second lens barrel.

In addition, the electrode pattern includes a plurality of electrode lines, and a shape formed by one ends of the plurality of electrode lines is a circular shape.

In addition, the first lens barrel and the second lens barrel are coupled to each other by an adhesive member.

In addition, the second region of the second lens barrel has a shape in which one side is open.

On the other hand, a camera device according to an embodiment includes a substrate portion; a second lens barrel disposed on the substrate portion; a first lens barrel including at least a part disposed in the second lens barrel; a variable focus lens disposed in the second lens barrel; and a first solid lens disposed in the first lens barrel, wherein at least a part of the first lens barrel includes a region spaced apart from an inner surface of the second lens barrel, and the second lens barrel includes an electrode pattern electrically connected to the variable focus lens and the substrate portion.

In addition, the substrate portion includes a first substrate, and the first substrate has an opening in which a part of the first lens barrel is disposed.

On the other hand, a lens module according to an embodiment includes a first lens barrel in which a first solid lens is disposed; and a second lens barrel including a first region in which a variable focus lens is disposed; wherein at least a part of the first lens barrel is disposed in the second lens barrel, and an inner periphery of the first region and an outer periphery of the variable focus lens have a circular shape, and a maximum width of the second lens barrel is greater than a maximum width of the first lens barrel.

In addition, an uppermost surface of the first lens barrel is disposed in the second lens barrel.

In addition, the first region has an inner periphery and a protrusion protruding inwardly from the inner periphery, wherein an outer surface of the variable focus lens is disposed to correspond to an inner periphery of the protrusion, and a diameter of the inner periphery of the protrusion is smaller than a diameter of the inner periphery of the first region.

### Advantageous Effects

A lens module according to the present embodiment includes a first lens barrel in which a first solid lens is disposed; and a second lens barrel disposed on the first lens barrel and in which a variable focus lens is disposed. In this case, the second lens barrel includes a protrusion corresponding to a side surface of the variable focus lens, and a shape of the variable focus lens viewed from the optical axis has a circular shape, and an inner periphery of the protrusion has a circular shape corresponding to the shape of the variable focus lens. In addition, a second solid lens as well as the variable focus lens may be additionally disposed in the second lens barrel. According to this, the plurality of solid lenses and the variable focus lens in the embodiment are combined by applying two lens barrels while the variable focus lens and the solid lens are combined and disposed in one second lens barrel, and accordingly, the structure of the lens module can be simplified to improve assembly, and thereby, the overall size of the lens module can be reduced. In addition, it can be assembled by easily performing alignment (eg, optical axis alignment) between the focus lens and the solid lens.

In addition, an electrode pattern electrically connected to the variable focus lens in the lens module according to the present embodiment is disposed on an inner periphery of the second lens barrel. Accordingly, an additional structure for disposing the electrode pattern may be removed by disposing an electrode pattern for controlling the variable focus lens in the lens barrel. In addition, a control signal in an embodiment may be transmitted to the variable focus lens through a shortest path, or state information of the variable focus lens may be obtained, and accordingly, the variable focus lens can be controlled in a more accurate state, and accordingly, operation reliability may be improved.

### DESCRIPTION OF DRAWINGS

FIG. 1 is a perspective view of a camera device according to a first embodiment.

FIG. 2 is an exploded perspective view of the camera device of the first embodiment shown in FIG. 1.

FIG. 3 is a view showing the case shown in FIGS. 1 and 2.

FIG. 4 is an exploded perspective view of a second lens portion according to the first embodiment.

FIG. 5 is a perspective view of the second lens barrel shown in FIG. 4.

FIG. 6 is a plan view of the second lens barrel shown in FIG. 5.

FIG. 7 is a bottom view of the second lens barrel shown in FIG. 5.

FIG. 8 is an exploded perspective view of a first lens portion according to the first embodiment.

FIG. 9 is a cross-sectional view showing a state in which the first lens portion and the second lens portion of FIG. 2 are combined.

FIG. 10 is a perspective view of a camera device according to a second embodiment.

FIG. 11 is a perspective view in a state in which the case shown in FIG. 10 is removed.

FIG. 12 is an exploded perspective view of a partial configuration of the camera device of FIG. 11.

FIG. 13 is an exploded perspective view of a lens module according to the second embodiment.

FIG. 14a is an exploded perspective view of a partial configuration of the camera device according to the second embodiment.

FIG. 14b is a bottom perspective view of a partial configuration of the camera device according to the second embodiment.

FIG. 15a is an exploded perspective view of a partial configuration of the camera device according to the second embodiment.

FIG. 15b is a cross-sectional view taken along line C-C of a state in which a partial configuration of the camera device of FIG. 15a are combined.

FIG. 15c is a cross-sectional view taken along line D-D of a state in which a partial configuration of the camera device of FIG. 15a are combined.

FIGS. 16 and 17 are exploded perspective views of a partial configuration of the camera device according to the second embodiment viewed from a direction different from that of FIG. 15A.

FIG. 18 is an exploded perspective view of an image sensor module of the camera device according to the second embodiment.

FIG. 19 is an exploded perspective view of the image sensor module of the camera device according to the second embodiment viewed from a different direction from that of FIG. 18.

FIG. 20 is a view for explaining x-axis direction shift drive through a partial configuration of the camera device according to the second embodiment.

FIG. 21 is a view for explaining y-axis direction shift drive through a partial configuration of the camera device according to the second embodiment.

FIG. 22 is a view for explaining z-axis rotational drive through a partial configuration of the camera device according to the second embodiment.

FIG. 23 (a) is a view showing magnets disposed on a base together with the x-axis and y-axis, FIG. 23 (b) is a view showing the base, the magnets and coils with the z-axis direction rotational drive.

FIG. 24 is a dview showing a magnetic flow and a Lorentz force between a magnet and a coil of the camera device according to the second embodiment.

FIG. 25 is a perspective view of an optical device according to the present embodiment.

FIG. 26 is a configuration diagram of the optical device shown in FIG. 25.

### DETAILED DESCRIPTION OF THE EMBODIMENTS

Hereinafter, embodiments of the present invention will be described in detail with reference to the accompanying drawings.

However, the spirit and scope of the present invention is not limited to a part of the embodiments described, and may be implemented in various other forms, and within the spirit and scope of the present invention, one or more of the elements of the embodiments may be selectively combined and substituted for use.

In addition, unless expressly otherwise defined and described, the terms used in the embodiments of the present invention (including technical and scientific terms may be construed the same meaning as commonly understood by one of ordinary skill in the art to which this invention belongs, and the terms such as those defined in commonly used dictionaries may be interpreted as having a meaning that is consistent with their meaning in the context of the relevant art. Further, the terms used in the embodiments of the present invention are for describing the embodiments and are not intended to limit the present invention.

In this specification, the singular forms may also include the plural forms unless specifically stated in the phrase, and may include at least one of all combinations that may be combined in A, B, and C when described in “at least one (or more) of A (and), B, and C”. Further, the terms such as first, second, A, B, (a), and (b) may be used in describing the elements of the embodiments of the present invention.

These terms are only used to distinguish the elements from other elements, and the terms are not limited to the essence, order, or order of the elements. In addition, when an element is described as being “connected”, “coupled”, or “contacted” to another element, it may include not only when the element is directly “connected” to, “coupled” to, or “contacted” to other elements, but also when the element is “connected”, “coupled”, or “contacted” by another element between the element and other elements.

In addition, when described as being formed or disposed “on (over)” or “under (below)” of each element, the “on (over)” or “under (below)” may include not only when two elements are directly connected to each other, but also when one or more other elements are formed or disposed between two elements. Further, when expressed as “on (over)” or “under (below)”, it may include not only the upper direction but also the lower direction based on one element.

[symbol]

Hereinafter, a lens module and a camera device including the same according to an embodiment will be described.

“Optical axis direction” used below is defined as an optical axis direction of a lenses (solid lenses and variable focus lenses) 0 and/or an image sensor coupled to a lens driving device.

“Vertical direction” used below may be a direction parallel to the optical axis direction. The vertical direction may correspond to “z-axis direction”. “Horizontal direction” used below may be a direction perpendicular to the vertical direction. That is, the horizontal direction may be a direction perpendicular to the optical axis. Therefore, the horizontal direction may include “x-axis direction” and “y-axis direction”.

“Auto focus function” used below is defined as a function for automatically adjusting a focus on a subject by adjusting a distance from an image sensor and moving a lens in the optical axis direction according to the distance of the subject so that a clear image of the subject may be obtained on the image sensor. Meanwhile, “auto focus” may correspond to “AF (Auto Focus)”.

“Camera shake correction function” used below is defined as a function of moving the lens and/or the image sensor so as to cancel vibration (movement) generated in the image sensor by external force. Meanwhile, “Camera shake correction function” may correspond to “Optical Image Stabilization (OIS).

[symbol]

### Camera Device of a First Embodiment

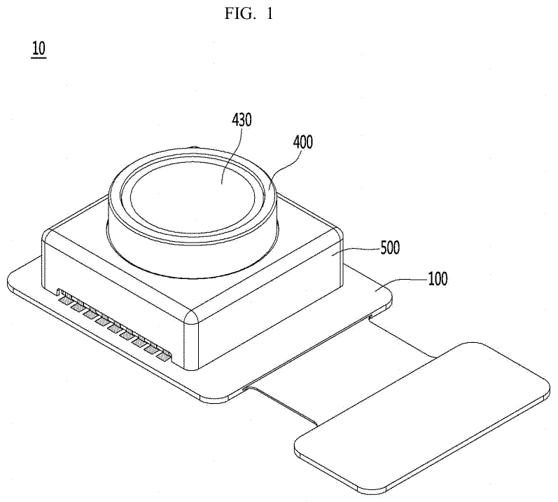

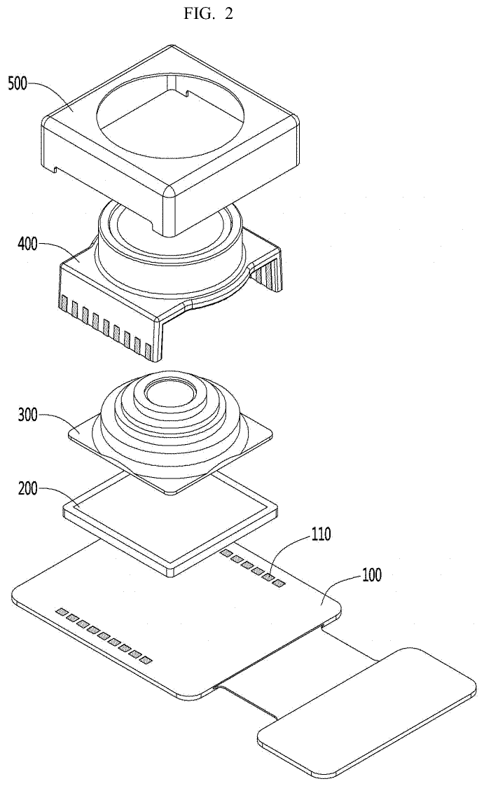

FIG. 1 is a perspective view of a camera device according to a first embodiment, and FIG. 2 is an exploded perspective view of the camera device of the first embodiment shown in FIG. 1.

The camera device according to the first embodiment may be a camera device equipped with an autofocus (AF) function. For example, the camera device of the first embodiment may have a function of automatically focusing on the subject by changing an interface state of a variable focus lens according to a distance of a subject so that a clear image of the subject can be obtained from the image sensor. For example, the camera device according to the first embodiment may implement handshake correction by changing the interface state of the variable focus lens.

For this purpose, the camera device 10 according to the first embodiment may include a substrate 100, an image sensor portion 200, lens modules 300 and 400, and a case 500.

The lens modules 300 and 400 may include a lens and a lens barrel. The lens modules 300 and 400 may include a lens barrel capable of accommodating one or more lenses. Preferably, the lens modules 300 and 400 may include a first lens portion 300 including a first solid lens and a first lens barrel accommodating the first solid lens, and a second lens portion 400 including a variable focus lens and a second lens barrel a second solid lens.

The light passing through the lens modules 300 and 400 may be irradiated to the image sensor constituting the image sensor portion 200. For this, the lens modules 300 and 400 may include a plurality of solid lenses and a variable focus lens. Here, the variable focus lens may be, for example, a liquid lens. That is, the lens modules 300 and 400 may include a variable focus lens consisting of a liquid lens and a solid lens. The liquid lens includes a conductive liquid and a non-conductive liquid, and an interface formed between the conductive liquid and the non-conductive liquid may be controlled by an electrical force. The liquid lens may be referred to as a variable focus lens whose focal length is adjusted by adjusting the interface.

The camera device may include a substrate 100 disposed under the lens modules 300 and 400 to be coupled to the lens modules 300 and 400.

In addition, an image sensor portion 200 including an image sensor aligned on an optical axis with the lens modules 300 and 400 may be disposed on the substrate 100.

In addition, the camera device 10 may include a case 500 disposed on the substrate 100 and having an accommodation space therein.

The case 500 may be a portion for protecting from external impact by embedding parts such as the image sensor portion 200 and the lens modules 300 and 400 described above. To this end, the case 500 is not limited to a special shape, but may be formed in a rectangular shape to have an accommodating space therein. For example, the case 500 may be formed of a plastic material strong against external impact.

Alternatively, the case 500 may be a shield can. Accordingly, the case 500 may serve to shield the electromagnetic wave (EMI) by enclosing the image sensor portion 200 and the lens modules 300 and 400 as a whole. The case 500 may be directly coupled to the substrate 100 while surrounding the image sensor portion 200 and the lens modules 300 and 400.

The size of the case 500 corresponds to the size of the lens modules 300 and 400, and may be formed of a metal material such as iron to shield EMI.

The image sensor portion 200 may be fixedly disposed on the substrate 100. The image sensor portion 200 may include an image sensor. The image sensor may be any one of a charge coupled device (CCD), a metal oxide semi-conductor (MOS), a CPD, and a CID.

[symbol]

[symbol]

### Case of the First Embodiment

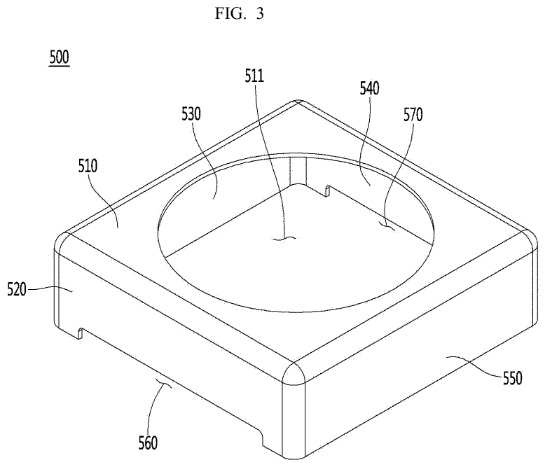

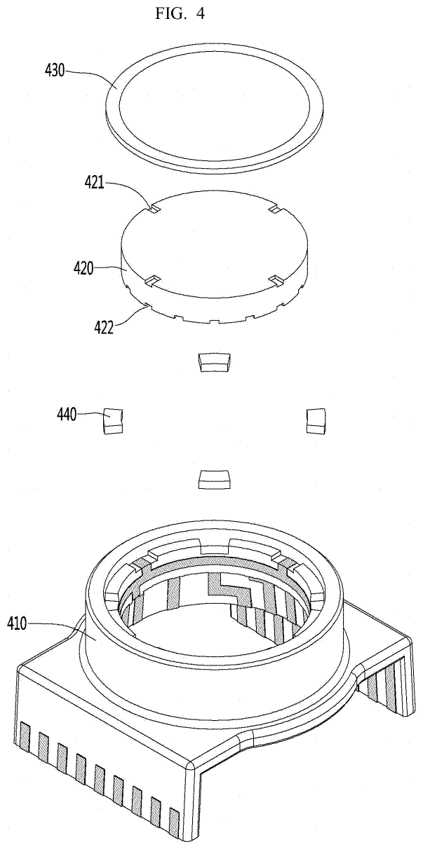

FIG. 3 is a view showing the case shown in FIGS. 1 and 2.

Referring to FIG. 3, the camera device 10 may include a case 500. The case 500 may be a case that covers parts constituting the camera device 10, and preferably, it may be a shield can.

The case 500 may be disposed to surround side parts of the lens modules 300 and 400 constituting the camera device 10.

The case 500 may have an open region 511 formed on its upper surface. The open region 511 of the case 500 may be a hollow hole. At least a part of the lens modules 300 and 400 may be disposed in the open region 511 of the case 500. Preferably, an upper portion of an uppermost lens among the plurality of lenses constituting the lens modules 300 and 400 may be exposed through the open region 511 of the case 500.

In this case, a diameter of the open region 511 of the case 500 may be larger than a diameter of an upper portion of the second lens portion 400 constituting the lens modules 300 and 400. Accordingly, at least a part of the second lens portion 400 may be disposed in the open region 511.

Specifically, the case 500 may include an upper plate 510 and a plurality of side plates 520, 530, 540, 550 that are curved or bent at the edge of the upper plate 510 and extend downwardly. For example, the upper plate 510 of the case 500 may have a rectangular shape, and accordingly, first to fourth side plates 520, 530, 540, and 550 may be formed to extend downwardly from the four edges of the upper plate 510. For example, the case 500 has the upper plate 510 formed with an open region 511 into which the second lens portion 400 of the lens modules 300 and 400 is inserted, and the case 500 may have a rectangular parallelepiped shape with an open bottom surface and rounded corners.

Meanwhile, exposure holes 550 and 560 may be formed on at least one of the four side plates 520, 530, 540, and 550 of the case 500. For example, exposure holes 550 and 560 may be formed on two side plates 520 and 540 facing each other among the four side plates 520, 530, 540, and 550 of the case 500. The exposure holes 550 and 560 may be formed on lower ends of the side plates 520 and 540 of the case 500. Accordingly, the lower ends of the four side plates 520, 530, 540, 550 of the case 500 include a part in contact with the substrate 100, and a part that is not in contact with the substrate 100 by the exposure holes 550.

The exposure holes 550 and 560 of the case 500 may expose electrodes (described later) of the substrate 100. The electrode may be an electrode included in the substrate 100 or an electrode included in the second lens portion 400. That is, the substrate 100 may include an electrode formed in regions exposed through the exposure holes 550 and 560. In addition, the electrode of the substrate 100 may be electrically connected to an electrode formed in the second lens portion 400. This will be described in more detail below.

The exposure holes 550 and 560 expose electrodes of the substrate 100 and the second lens portion 400, respectively, and a soldering process for electrically connecting the substrate 100 and the second lens portion 400 may be performed in the exposed region.

[symbol]

### Lens Module of the First Embodiment

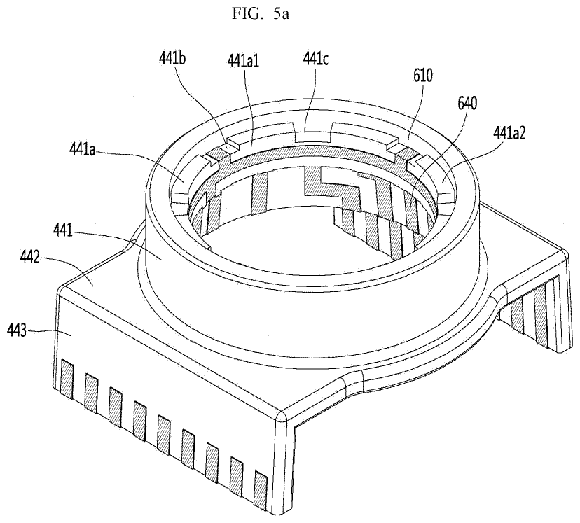

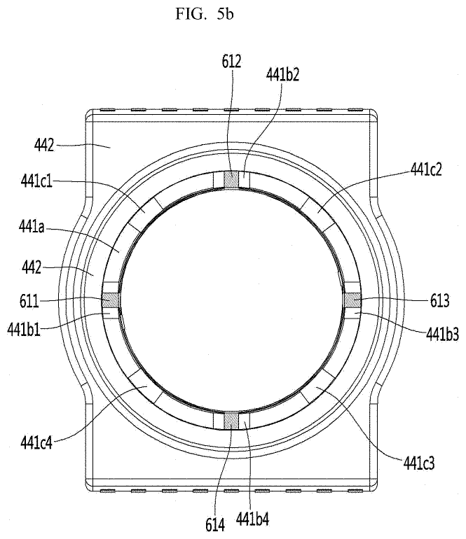

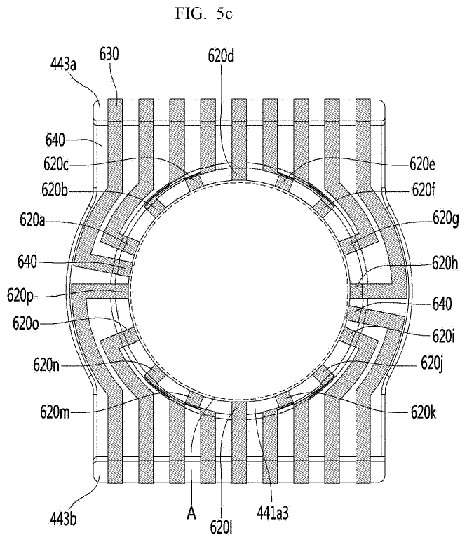

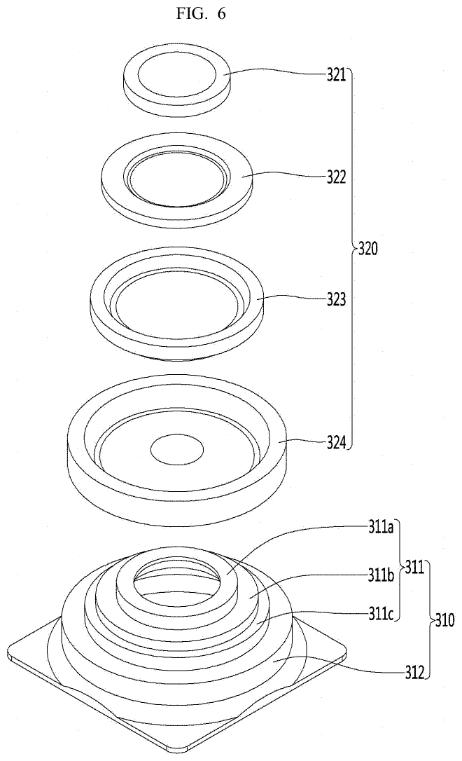

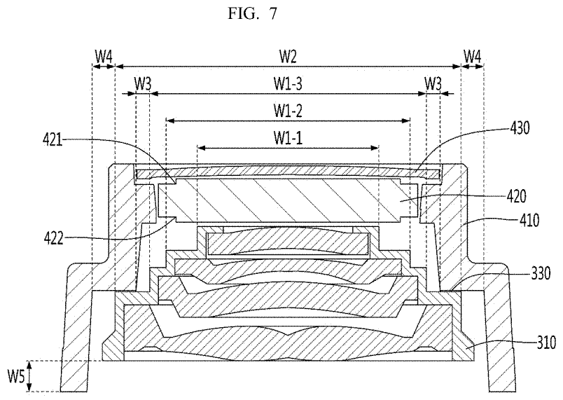

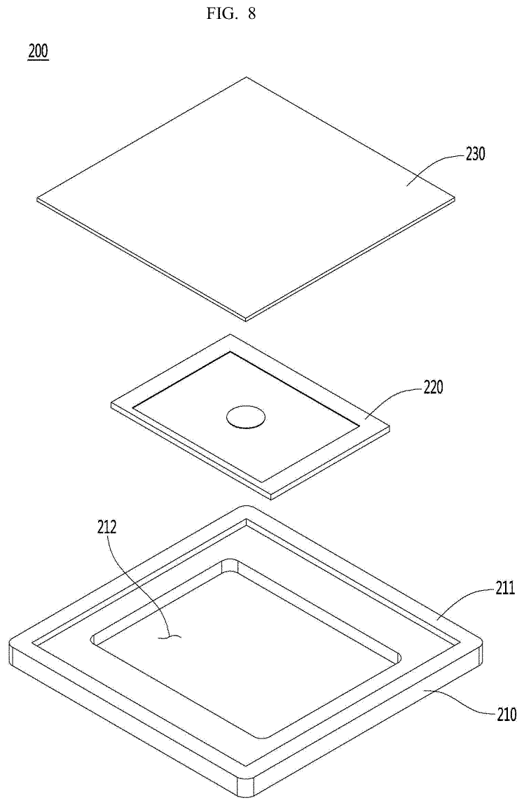

FIG. 4 is an exploded perspective view of a second lens portion according to the first embodiment, FIG. 5 is a perspective view of the second lens barrel shown in FIG. 4, FIG. 6 is a plan view of the second lens barrel shown in FIG. 5, FIG. 7 is a bottom view of the second lens barrel shown in FIG. 5, FIG. 8 is an exploded perspective view of a first lens portion according to the first embodiment, and FIG. 9 is a cross-sectional view showing a state in which the first lens portion and the second lens portion of FIG. 2 are combined.

The lens modules 300 and 400 according to the first embodiment will be described with reference to FIGS. 4 to 9.

The lens modules 300 and 400 include a first lens portion 300 and a second lens portion 400.

The first lens portion 300 may include a first lens barrel 310 and a first solid lens 320 disposed in the first lens barrel 310.

In addition, the second lens portion 400 may include a second lens barrel 410 and a variable focus lens 420 disposed in the second lens barrel 410. In addition, the second lens portion 400 may further include a second solid lens 430 disposed in the second lens barrel 410.

That is, the lens module in the embodiment may include a plurality of lenses. In addition, the plurality of lenses may include a first solid lens 320, a variable focus lens 420, and a second solid lens 430. In this case, the first solid lens 320, the variable focus lens 420, and the second solid lens 430 may not be commonly inserted and disposed in one lens barrel, but may be separately disposed in different lens barrels. In addition, the lens module in the embodiment does not have a structure in which the solid lenses 320 and 430 and the variable focus lens 420 are manufactured in different packages and then coupled to each other. That is, the second solid lens 430 and the variable focus lens 420 in the embodiment may be commonly disposed in one second lens barrel 410. According to this, the variable focus lens 420 and the second solid lens 430 in the embodiment are disposed in one second lens barrel 410, a plurality of solid lenses 320, 430 and a variable focus lens (420) are combined by applying two lens barrels, and accordingly, it is possible to simplify the structure of the lens module to improve assembly, and furthermore, the overall size can be reduced.

At this time, the first solid lens 320, the variable focus lens 420, and the second solid lens 430 of the first lens barrel 310 and the second lens barrel 410 may be arranged to be aliged in the optical axis. For example, the first solid lens 320, the variable focus lens 420, and the second solid lens 430 may be arranged and aligned based on a central axis to form one optical system.

Meanwhile, the variable focus lens 420 may be disposed between the first solid lens 320 and the second solid lens 430 in the first lens barrel 310 and the second lens barrel 410, For example, the variable focus lens 420 may be disposed in front of the first solid lens 320 with respect to the optical axis and may be disposed in the rear of the second solid lens 430. For example, light incident from the outside may pass through the second solid lens 430 and be incident on the variable focus lens 420. In addition, the light incident to the variable focus lens 420 may pass through the variable focus lens 420 to be incident on the first solid lens 320 again. However, the lens module of the embodiment is not limited thereto, and the structure thereof may vary according to specifications required for the camera module. For example, the disposition positions of the first solid lens 320, the second solid lens 430, and the variable focus lens 420 may be interchanged, and at least one of the first solid lens 320 and the second solid lens 430 may be omitted in some cases.

The first solid lens 320 may be composed of a plurality of lenses. For example, the first solid lens 320 may include four lenses. For example, the first solid lens 320 may include a first-first solid lens 321, a first-second solid lens 322, a first-third solid lens 323, and a first-fourth solid lens 324. However, the embodiment is not limited thereto, and the first solid lens 320 may be composed of three lenses or less, or alternatively, five lenses or more.

The first lens barrel 310 may include a receiving portion for accommodating a first-first solid lens 321, a first-second solid lens 322, a first-third solid lens 323, and a first-fourth solid lens 324. In this case, the first-first solid lens 321, the first-second solid lens 322, the first-third solid lens 323, and the first-fourth solid lens 324 may have different widths, respectively. Accordingly, an outer surface of the first lens barrel 310 may have a stepped portion. That is, the outer surface of the first lens barrel 310 may include a first stepped portion 311a corresponding to an arrangement region of the first-first solid lens 321, a second stepped portion 311b corresponding to an arrangement region of the first-second solid lens 322, a third stepped portion 311c corresponding to an arrangement region of the first-third solid lenses 323, and a fourth stepped portion 312 corresponding to an arrangement region of the first-fourth solid lens 324.

In this case, the first stepped portion 311a, the second stepped portion 311b, and the third stepped portion 311c may be referred to as a first region 311 of the outer surface of the first lens barrel 310, and the fourth stepped portion 312 may be referred to as a second region 312 of the outer surface of the first lens barrel 310. Here, the first lens barrel 310 may be disposed in the second lens barrel 410. In addition, the first region 311 and the second region 312 of the first lens barrel 310 may be divided by a difference in an arrangement region within the second lens barrel 410. This will be described in more detail below.

Outer widths of the first stepped portion 311a, the second stepped portion 311b, the third stepped portion 311c, and the fourth stepped portion 312 may be different from each other. For example, the outer width of the first lens barrel 310 corresponding to the first stepped portion 311a may be smaller than the outer width of the first lens barrel 310 corresponding to the second stepped portion 311b. Also, the outer width of the first lens barrel 310 corresponding to the second stepped portion 311b may be smaller than the outer width of the first lens barrel 310 corresponding to the third stepped portion 311c. Meanwhile, it has been described that the first region 311 of the outer surface of the first lens barrel 310 includes three stepped portions. However, the embodiment is not limited thereto, and the number of stepped portions of the first region 311 may be changed according to the number of the first solid lenses 320. For example, when the number of the first solid lenses 320 is two, the stepped portion of the first region 311 may be one.

In this case, a width of the first region 311 of the first lens barrel 310 may be different from a width of the second region 312. Preferably, the first region 311 of the first lens barrel 310 may have a first width W1, and the second region 312 may have a second width W2 greater than the first width W1.

The first lens barrel 310 according to the first embodiment may be disposed in the second lens barrel 410. In addition, at least a part of the outer surface of the first lens barrel 310 may include a region spaced apart from an inner side of the second lens barrel 410. For example, an outer surface of the first lens barrel 310 extending in a direction parallel to the optical axis may be spaced apart from an inner surface of the second lens barrel 410 extending in a direction parallel to the optical axis. Here, the spaced apart region may be a space for optical axis alignment (AA: Active Align or Active Alignment) between a first solid lens 320 disposed in the first lens barrel 310, a variable focus lens 420 and a second solid lens disposed in the second lens barrel 410. This will be further described below.

Also, an outer surface of the first lens barrel 310 extending in a direction perpendicular to the optical axis may contact an inner surface of the second lens barrel 410. That is, an outer surface of the first lens barrel 310 extending in a direction perpendicular to the optical axis may contact an inner surface extending in a direction perpendicular to the optical axis among the inner surfaces of the second lens barrel 410. The contact region may be a portion for assembling the first lens barrel 310 to the second lens barrel 410. That is, active alignment between the first solid lens 320, the variable focus lens 420, and the second solid lens 430 can be performed using the spaced apart region, and the first lens barrel 310 and the second lens barrel 410 may be coupled to each other using an adhesive member applied to the contact region.

Adhesive members in the following may be epoxy.

A voltage is applied to the variable focus lens 420 in a state where the epoxy corresponding to the adhesive member is applied between the first lens barrel 310 and the second lens barrel 410, the epoxy is provisionally cured after aligning the optical axis with the first solid lens 320, and thereafter, the epoxy may be fully cured to perform AA between the first lens portion 300 and the second lens portion 400.

[symbol]

Meanwhile, the second lens portion 400 may include a second lens barrel 410, a variable focus lens 420, and a second solid lens 430.

The second lens barrel 410 may be coupled to the first lens barrel 310. At least a part of an inner surface of the second lens barrel 410 may contact at least a part of an outer surface of the first lens barrel 310. Preferably, an adhesive member is disposed between at least a part of an inner surface of the second lens barrel 410 and at least a part of an outer surface of the first lens barrel 310, so that the first lens barrel 310 and the second lens The barrels 410 may be coupled to each other.

The variable focus lens 420 may be disposed on the first solid lens 320 of the first lens barrel 310 in the second lens barrel 410. Preferably, when the first solid lens 320 is composed of a plurality of lenses, the variable focus lens 420 is disposed on the first-first solid lens 321 of the first solid lens 320 disposed at an uppermost portion.

The variable focus lens 420 may be a liquid lens. For example, the variable focus lens 420 may include a lens region in which a liquid is disposed. For example, the lens region of the variable focus lens 420 may include two types, namely, a conductive liquid and a non-conductive liquid, and the conductive liquid and the non-conductive liquid may form an interface without being mixed with each other. And, the interface between the conductive liquid and the non-conductive liquid constituting the variable focus lens 420 is deformed by a driving voltage applied through an electrode pattern 600 to be described later, so that a curvature of the interface or a focal length of the variable focus lens 420 can be changed. When a boundary surface is deformed or the curvature is changed, the variable focus lens 420 and the camera device including the same may perform an auto-focusing function and/or a hand-shake correction function.

As such, the variable focus lens 420 may include a plurality of electrodes. For example, the variable focus lens 420 may include a first electrode 421 disposed on one surface and a plurality of second electrodes 422 disposed on the other surface opposite to the one surface. Here, the plurality of first electrodes 421 may be referred to as a common electrode, and the plurality of second electrodes 422 may be referred to as individual electrodes. In, the first electrode may receive a voltage through the electrode pattern 600. In addition, the plurality of second electrodes 422 corresponding to the individual electrodes may be respectively disposed in different directions on the other surface to receive a driving voltage from the electrode pattern 600. That is, the plurality of second electrodes 422 may be disposed to have the same angular distance based on the central axis of the variable focus lens 420, and may include, for example, eight individual electrodes. And, when a voltage is applied to the eight individual electrodes, the interface between the conductive liquid and the non-conductive liquid constituting the variable focus lens 420 may be deformed by the driving voltage formed by interaction with the voltage applied to the first electrode 421. Also, the plurality of second electrodes 422 may include a heater electrode and a sensor electrode. The heater electrode may be an electrode for heating a heater in order to maintain the temperature of the variable focus lens 420 at a constant temperature. As an example, the heater may be composed of two, accordingly, four heater electrodes may be configured to be respectively connected to positive (+) and negative (−) terminals of the two heaters. In addition, the sensor electrode may be connected to a temperature sensor for sensing the temperature of the variable focus lens 420 in order to determine whether the heater is driven. As an example, the temperature sensor may be composed of two, accordingly, four sensor electrodes may be configured to be respectively connected to positive (+) terminals and negative (−) terminals of the two temperature sensors. Accordingly, the plurality of second electrodes 422 may include eight individual electrodes, four heater electrodes, and four sensor electrodes. However, the embodiment is not limited thereto, the number of the heater electrode and the sensor electrode is changed or the heater electrode and the sensor electrode may be omitted. Also, the number of the individual electrodes may be selectively increased or decreased.

The second solid lens 430 may be disposed on the variable focus lens 420 in the second lens barrel 410. For example, the second solid lens 430 may be disposed at an uppermost portion of the lenses constituting the optical system, and accordingly, at least a part thereof may protrude above the second lens barrel 410 and be exposed to the outside. In this case, a surface of the second solid lens 430 may be damaged by exposing the second solid lens 430 to the outside. If the surface of the lens is damaged, an image quality of an image captured by the camera device may be deteriorated. Accordingly, a cover glass or a coating layer may be formed on the surface of the second solid lens 430 to prevent or suppress surface damage.

The second lens barrel 410 may be disposed on the first lens barrel 310 to be coupled to the first lens barrel 310. Preferably, the first lens barrel 310 may be disposed in the second lens barrel 410 to be coupled to the second lens barrel 410.

The variable focus lens 420 and the second solid lens 430 may be disposed in the second lens barrel 410.

In this case, the second lens barrel 410 may include a first region including a first sidewall 441 and an extension portion 442 extending outwardly from the first sidewall 441.

Also, the second lens barrel 410 may include a second region including a second sidewall 443 extending downwardly from an end of the extension portion 442.

The first sidewall 441 may extend in a direction parallel to the optical axis direction. That is, the first sidewall 441 may include an inner surface and an outer surface extending in a direction substantially parallel to the optical axis direction.

Also, the extension portion 442 may extend from one end of the first sidewall 441 in a direction perpendicular to the optical axis direction. Preferably, the extension portion 442 may include an inner surface and an outer surface extending in a direction substantially perpendicular to the optical axis direction.

Also, the second sidewall 443 may extend in a direction parallel to the optical axis direction. That is, the second sidewall 443 may include an inner surface and an outer surface extending in a direction substantially parallel to the optical axis direction.

In this case, the variable focus lens 420 and the second solid lens 430 may be disposed in a first region of the second lens barrel 410 formed of the first sidewall 441. Also, at least a part of the first region 311 of the first lens barrel 310 may be disposed in the first region of the second lens barrel 410 formed of the first sidewall 441. In this case, at least a part of an inner surface of the first sidewall 441 may be spaced apart from at least a part of an outer surface of the first region 311 of the first lens barrel 310. Also, an entire region of the inner surface of the first sidewall 441 may be spaced apart from an entire region of the outer surface of the first region 311 of the first lens barrel 310. This may vary depending on the results of Active Align (AA) of the first lens barrel 310 and the second lens barrel 410.

The extension portion 442 may be coupled to the second region 312 of the first lens barrel 310 by the above-described adhesive member (to be described later). For example, a second adhesive member 330 may be disposed between the inner surface of the extension portion 442 and an upper surface of the second region 312 of the first lens barrel 310, and the first lens barrel 310 and the second lens barrel 410 may be coupled to each other by the second adhesive member 330.

At least a part of the first lens barrel 310 may be disposed in the second region of the second lens barrel 410 formed of the second sidewall 443. For example, the second region 312 of the first lens barrel 310 may be disposed in the second region of the second lens barrel 410 corresponding to the second sidewall 443. In addition, at least a part of an inner surface of the second region of the second lens barrel 410 may be spaced apart from at least a part of an outer surface of the second region 312 of the first lens barrel 310.

Meanwhile, the second sidewall 443 may extend downwardly from at least a part of an end of the extension portion 442. Accordingly, at least one side of the second region of the second lens barrel 410 corresponding to the second sidewall 443 may have an open shape. In this case, the lens module according to the first embodiment may be supported by the second sidewall 443 of the second lens barrel 410 and disposed on the substrate 100. Accordingly, the second sidewall 443 may includes a second-first sidewall 443a and a second-second sidewall 443b extending downwardly from two opposite ends of end portions the extension portion 442. In addition, the second-first sidewall 443a and the second-second sidewall 43b may be disposed to face each other at positions spaced apart from each other by a predetermined distance. Accordingly, a region between the second-first sidewall 443a and the second-second sidewall 443b may be opened.

A first region of the second lens barrel 410 may include a protrusion 441a. That is, the protrusion 441a corresponding to a side surface of the variable focus lens 420 may be formed on an inner periphery of the first sidewall 441 of the second lens barrel 410. The protrusion 441a may be disposed to protrude inwardly from the inner periphery of the first sidewall 441. In this case, an upper surface of the protrusion 441a may be positioned lower than an upper surface of the first sidewall 441. Accordingly, a stepped portion may be formed between the upper surface of the protrusion 441a and the upper surface of the first sidewall 441. In addition, the stepped portion formed between the upper surface of the protrusion 441a and the upper surface of the first sidewall 441 may function as a seating part on which the second solid lens 430 is seated.

An inner periphery of the protrusion 441a may be in contact with an outer periphery of the variable focus lens 420. That is, an inner surface of the protrusion 441a and an outer surface of the variable focus lens 420 may contact each other. In this case, the protrusion 441a may be formed along the outer surface of the variable focus lens 420 on the inner periphery of the first sidewall 441. In addition, the inner periphery of the protrusion 441a may have a shape corresponding to the outer periphery of the variable focus lens 420.

In this case, the variable focus lens 420 may have a circular shape when viewed in the optical axis direction. That is, the variable focus lens 420 may have a circular cross-sectional shape in a direction perpendicular to the optical axis direction.

Accordingly, the inner periphery of the protrusion 441a may have a circular shape. In addition, the outer surface of the protrusion 441a, more clearly the outer periphery of the first sidewall 441 on which the protrusion 441a is formed may have a circular shape.

Meanwhile, the inner periphery of the protrusion 441a and the outer surface of the variable focus lens 1222 may have an elliptical shape as well as a circular shape.

Recesses 441b and 441c may be formed on an upper surface of the protrusion 441a. The recesses 441b and 441c may have a shape concave downwardly from the upper surface of the protrusion 441a. An electrode pattern 600 may be disposed in the recesses 441b and 441c. Also, a first adhesive member 440 may be disposed in the recesses 441b and 441c. The recesses 441b and 441c may include a first recess 441b in which the electrode pattern 600 is disposed and a second recess 441c in which the first adhesive member 440 is disposed.

The first recesses 441b may be disposed to be spaced apart from each other at the same distance on the upper surface of the protrusion 441a. The electrode pattern 600 may be disposed in the first recess 441b. Preferably, a first lead pattern portion 610 electrically connected to the first electrode 421 of the variable focus lens 420 may be disposed in the first recess 441b.

That is, the electrode pattern 600 may be included an electrode line 640 connecting between a plurality of lead pattern portions 610, 620, 630 and the plurality of lead pattern portions 610, 620, 630 connected to each of electrodes disposed in different configurations. In this case, the plurality of lead pattern portions 610, 620, and 630 may include a a first lead pattern portion 610 connected to the first electrode 421 of the variable focus lens 420, a second lead pattern portion 620 connected to the second electrode 422 of the variable focus lens 420, and a third lead pattern portion 630 connected to the electrode 110 of the substrate 100.

In addition, the first lead pattern portion 610 may be formed in a first recess 441b formed on an upper surface of the protrusion 441a. In addition, the first lead pattern portion 610 may be electrically connected to the first electrode 421 disposed on one surface of the variable focus lens 420 by soldering or the like in a state in which the outer periphery of the variable focus lens 420 is in contact with the inner periphery of the protrusion 441a.

Meanwhile, the number of first electrodes 421 of the variable focus lens 420 may be four. Accordingly, the first recess 441b may include first-first to fourth-first recesses 441b1, 441b2, 441b3, and 441b4 spaced apart from each other at the same distance from each other. In addition, the first lead pattern portion 610 may include first-first to first-fourth lead patterns 611, 612, 613, 614 disposed in each of the first-first to fourth-first recesses 441b1, 441b2, 441b3, and 441b4 and electrically connected to each of the four first electrodes 421.

In this case, the upper surface of the protrusion 441a may contact a lower surface of the second solid lens 430. Here, when the second solid lens 430 and the first lead pattern portion 610 are in direct contact with each other, a problem may occur in the reliability of the first lead pattern portion 610. Accordingly, the first lead pattern portion 610 is disposed in the first recess 441b so that the first lead pattern part 610 and the second solid lens 430 do not directly contact each other.

Meanwhile, a second recess 441c may be formed between the plurality of first recesses 441b. A first adhesive member 440 may be disposed in the second recess 441c. The first adhesive member 440 is disposed in the second recess 441c so that the variable focus lens 420 and the second solid lens 430 can be coupled within the second lens barrel 410. In this case, the first adhesive member 440 may be disposed in the second recess 441c as described above in order to prevent it from flowing into an region other than a designated region. The second recess 441c may function as a dam to prevent the flow of the first adhesive member 440.

In this case, the second recess 441c may include a second-first recess to a second-fourth recesses disposed between each of the first-first recesses to the first-fourth recesses 441b1, 441b2, 441b3, 441b4. However, the embodiment is not limited thereto, and the number of the second recesses 441c may increase or decrease.

On the other hand, the shape formed by one ends of the first lead pattern portion 610 disposed in the plurality of first recesses 441b may correspond to the shape of the inner periphery of the protrusion 441a or the shape of the variable focus lens 420. Preferably, the shape formed by one ends of the first lead pattern portion 610 constituting the electrode pattern 600 may be circular. In this case, the shape of one ends of the first lead pattern portion 610 has been described as having a circular shape in the above description, but the first lead pattern portion 610 is substantially integrally formed with the electrode line 640, and accordingly, this may mean that the shape formed by one ends of the electrode line 640 is a circular shape.

Meanwhile, a plurality of second lead pattern portions 620 may be disposed on a lower surface of the protrusion 441a. The plurality of second lead pattern portions 620 may be connected to the second electrode 422 of the variable focus lens 420.

That is, the second lead pattern portion 620 may be electrically connected to the second electrode 422 disposed on the other surface of the variable focus lens 420 by soldering or the like in a state in which the outer periphery of the variable focus lens 420 is in contact with the inner periphery of the protrusion 441a.

In this case, the number of the second lead pattern portion 620 may correspond to the number of the second electrodes 422 and may be disposed on the lower surface of the protrusion 441a. For example, the second lead pattern portion 620 may include 16 second lead patterns 620a, 620b, 620c, 620d, 620e, 620f, 620g, 620h, 620i, 620j, 620k, 620l, 620m, 620n, 620o, 620p disposed on the lower surface of the protrusion 441a to be spaced apart from each other by a predetermined interval. In addition, an electrode line 640 connected to the first lead pattern portion 610 disposed on the upper surface of the protrusion 441a as well as the second lead pattern portion 620 may also be disposed on a lower surface of the protrusion 441a.

Meanwhile, a lower surface of the second sidewall 443 may contact an upper surface of the substrate 100. Preferably, a third lead pattern portion 630 constituting the electrode pattern 600 may be disposed on a lower surface of the second sidewall 443. In addition, the third lead pattern portion 630 may be electrically connected to the electrode 110 of the substrate 100 while the second lens barrel 410 is coupled to the substrate 100.

In this case, the third lead pattern portion 630 may be disposed on the lower surface of the second sidewalls 443a and 443b, respectively, and may be connected to the first lead pattern portion 610 or the second lead pattern portion 620 through the electrode line 640.

On the other hand, the electrode pattern 600 in the embodiment may include the same number of electrode lines as the total number of the first and second electrodes 421 and 422 included in the variable focus lens 420, and alternatively, more electrode lines may be included than the total number of the first and second electrodes 421 and 422. That is, the electrode line 640 of the electrode pattern 600 may be connected 1:1 with the first and second electrodes 421 and 422, respectively. Alternatively, the electrode line 640 of the electrode pattern 600 may be branched from at least one of the first and second electrodes 421 and 422 into a plurality of lines. Alternatively, although not shown in the drawing, the electrode line 640 of the electrode pattern 600 may be additionally connected to not only the first and second electrodes 421 and 422 but also to electrodes of other configurations.

Meanwhile, as shown in FIG. 7, outer widths of the first stepped portion 311a, the second stepped portion 311b, the third stepped portion 311c and the fourth stepped portion 312 of the first lens barrel 310 may be different from each other. For example, the outer width of the first lens barrel 310 corresponding to the first stepped portion 311a may be smaller than the outer width of the first lens barrel 310 corresponding to the second stepped portion 311b. In addition, the outer width of the first lens barrel 310 corresponding to the second stepped portion 311b may be smaller than the outer width of the first lens barrel 310 corresponding to the third stepped portion 311c. Meanwhile, although it has been described that the first region of the outer surface of the first lens barrel 310 includes three stepped portions, it is not limited thereto, and the number of stepped portions of the first region 311 may be changed according to the number of the first solid lenses 320. For example, when the number of the first solid lenses 320 is two, the stepped portion of the first region 311 may be one.

In this case, the width of the first region 311 of the first lens barrel 310 may be different from the width of the second region 312. Preferably, the first region 311 of the first lens barrel 310 may have a first width W1, and the second region 312 may have a second width W2 greater than the first width W1.

However, three first solid lenses 320 are disposed in the first lens barrel 310, and accordingly, three stepped portions may be included on the first region 311.

An outer width of the first stepped portion 311a may be a first-first width W1-1. Also, an outer width of the second stepped portion 311b may be a first-second width W1-2 greater than the first-first width W1-1. Also, an outer width of the third stepped portion 311c may be a first-third width W1-2 greater than the first-second width W1-2. In addition, when only one stepped portion is included in the first region 311, the width of the first region 311 may have a firs width W1 corresponding to nay one of a first-first width W1-1, a first-second width W1-2, and a first-third width W1-3.

In addition, the second region 312 of the first lens barrel 310 corresponding to an outer surface of the fourth stepped portion 312 may have a second width W2 greater than the first width W1.

In this case, the first region 311 of the first lens barrel 310 may be disposed inside the first sidewall 441 of the second lens barrel 410. In addition, the second region 312 of the first lens barrel 310 may be disposed inside the second sidewall 443 of the second lens barrel 410.

In addition, a second adhesive member 330 may be disposed on the upper surface of the second region 312 of the first lens barrel 310, more clearly on the upper surface of the fourth stepped portion 312, and an inner surface of the extension portion 442 of the second lens barrel 410 may be disposed on the second adhesive member 330.

In this case, the entire region of the first lens barrel 310 in the first embodiment may be disposed in the second lens barrel 410. In addition, a predetermined separation space may exist between the outer surface of the first lens barrel 310 and the inner surface of the second lens barrel 410.

Specifically, a separation space corresponding to the third width W3 may exist between the outer surface of the first region 311 of the first lens barrel 310 and the inner surface of the first sidewall 441 of the second lens barrel 410. In addition, a separation space corresponding to the fourth width W4 may exist between the outer surface of the second region 312 of the first lens barrel 310 and the inner surface of the second sidewall 443 of the second lens barrel 410. In addition, the separation spaces corresponding to the third width W3 and the fourth width W4 may be formed for the AA between the variable focus lens 420 and the second solid lens 430 disposed in the second lens barrel 410 and the first solid lens 320.

Meanwhile, a lowermost surface of the first lens barrel 310 may be positioned higher than a lowermost surface of the second lens barrel 410. For example, the lower surface of the second region 312 of the first lens barrel 310 and the lower surface of the second sidewall 443 of the second lens barrel 410 may be spaced apart by a fifth width W5. In addition, a separation space corresponding to the fifth width W5 may be an arrangement space of the image sensor portion 200 on the substrate 100, and preferably, it may separate the image sensor portion 200 and the first lens barrel 310 by a predetermined interval.

[symbol]

### Image Sensor Portion of the First Embodiment

FIG. 8 is an exploded perspective view of an image sensor portion according to the first embodiment.

Referring to FIG. 8, the image sensor portion 200 may include a sensor holder 210, an image sensor 220, and a filter 230.

The sensor holder 210 may include an open region 212. Preferably, the sensor holder 210 may be a holder for disposing the filter 230 on the image sensor 220 in a state in which the image sensor 220 disposed on the substrate 100 is exposed through the open region 212.

To this end, the sensor holder 210 may include a protrusion 211 extending upwardly from an edge thereof. That is, the sensor holder 210 may have a stepped portion formed through the protrusion 211, and the filter 230 may be disposed on the stepped portion.

An image sensor 220 may be disposed on the substrate 100. In addition, the image sensor 220 may be exposed through the open region 212 of the sensor holder 210.

An adhesive member (not shown) may be disposed on the stepped portion formed by the protrusion 210, and the filter 230 may be fixedly disposed on the adhesive member. The filter 230 may serve to block light of a specific frequency band from being incident on the image sensor 220 in light passing through the lens modules 300 and 400. The filter 230 may be disposed to be parallel to the x-y plane. The filter 230 may be disposed between the lens modules 300 and 400 and the image sensor 220. The filter 230 may include an infrared filter. The infrared filter may absorb or reflect infrared rays incident to the infrared filter.

The image sensor 220 may refer to a configuration in which light passing through the lens module and the filter 230 is incident to form an image. The image sensor 220 may be mounted on the substrate 100. The image sensor 220 may be electrically connected to the substrate 100. For example, the image sensor 220 may be coupled to the substrate 100 by a surface mounting technology (SMT). As another example, the image sensor 220 may be coupled to the substrate 100 by flip chip technology. The optical axis of the image sensor 220 may be arranged to coincide with the optical axis of the lens module. That is, the optical axis of the image sensor 220 and the optical axis of the lens module may be aligned. The image sensor 220 may convert light irradiated to an effective image region of the image sensor 220 into an electrical signal. In addition, the converted electrical signal may be an image signal. The image sensor 220 may be any one of a charge coupled device (CCD), a metal oxide semi-conductor (MOS), a CPD, and a CID.

[symbol]

### Substrate of the First Embodiment

FIG. 9 is a view showing a substrate according to the first embodiment.

Referring to FIG. 9, the substrate 100 may include a first substrate region 100a and a second substrate region 100b. The first substrate region 100a may be a region disposed in the case 500, and the second substrate region 100b may be a region exposed to an outside of the case 500. Preferably, a connector (not shown) may be formed on the second substrate region 100b, and may be connected to the main board through the connector.

The substrate 100 may include an electrode 110 disposed on one surface of the first substrate region 100a.

In this case, the electrodes 110 may be respectively disposed on each of both sides of the image sensor arrangement region 120 positioned at in the center.

Preferably, the electrode 110 may include a first electrode portion 111 electrically connected to the third lead pattern portion 630 disposed on the lower surface of the second-first sidewall 443a of the second lens barrel 410 and a second electrode portion 112 electrically connected to the third lead pattern portion 630 disposed on a lower surface of the second-second second sidewall 443b.

Meanwhile, the image sensor 220 may be disposed on the image sensor arrangement region 120 of the first substrate region 100a.

The lens module according to the present embodiment includes a first lens barrel in which a first solid lens is disposed; and a second lens barrel disposed on the first lens barrel and in which a variable focus lens is disposed. In this case, the second lens barrel includes a protrusion corresponding to a side surface of the variable focus lens, and a shape of the variable focus lens viewed from the optical axis has a circular shape, and an inner periphery of the protrusion has a circular shape corresponding to the shape of the variable focus lens. In addition, a second solid lens as well as the variable focus lens may be additionally disposed in the second lens barrel. According to this, the plurality of solid lenses and the variable focus lens in the embodiment are combined by applying two lens barrels while the variable focus lens and the solid lens are combined and disposed in one second lens barrel, and accordingly, the structure of the lens module can be simplified to improve assembly, and thereby, the overall size of the lens module can be reduced.

In addition, the electrode pattern electrically connected to the variable focus lens in the lens module according to the present embodiment is disposed on an inner periphery of the second lens barrel. Accordingly, an additional structure for disposing the electrode pattern may be removed by disposing an electrode pattern for controlling the variable focus lens in the lens barrel. In addition, a control signal in an embodiment may be transmitted to the variable focus lens through a shortest path, or state information of the variable focus lens may be obtained, and accordingly, the variable focus lens can be controlled in a more accurate state, and accordingly, operation reliability may be improved.

[symbol]

Hereinafter, the camera device 1000 according to a second embodiment will be described.

The camera device 1000 in the second embodiment is different from the camera device 10 in the first embodiment in the shape of the second lens barrel 410 constituting the lens modules 300 and 400, the substrate 100, and an actuator 1000A disposed under the lens modules 300 and 400. Hereinafter, the camera device 10000 of the second embodiment will be described as a whole, and a detailed description thereof will be omitted for parts substantially the same as those of the camera device 10 of the first embodiment.

[symbol]

First, the camera device 10 in the first embodiment includes only one actuator. Here, the one actuator may be implemented by the variable focus lens 420 constituting the lens module.

Alternatively, the AF function of the camera apparatus in the second embodiment may be performed through the variable focus lens, and the hand shake correction function may be performed by an additional actuator 1000A. Alternatively, the actuator 1000A may perform both the AF function and the hand shake correction function.

The camera device according to the second embodiment performs a handshake correction function and/or an autofocus function by moving the image sensor module 1400 respect to the lens module.

That is, recently, as the camera technology has been developed, an image resolution has been increased, thereby increasing a size of the image sensor 1440. At this time, as the size of the image sensor 1440 increases, a size of the lens module 1100 and parts of the actuator for shifting the lens module 1100 are also increase. Accordingly, as a weight of the other actuator components for shifting the lens module 1100 as well as the weight of the lens module 1100 increases, it is difficult to stably shift the lens module 1100 using the conventional VCM technology, and a lot of problems occur in terms of reliability.

Accordingly, AF in the second embodiment is performed using the variable focus lens, and OIS is performed using the actuator 1000A implementing the image sensor shift method, thereby, the reliability of the camera device is improved.

Furthermore, there is a 5-axis camera shake in the camera shake of the camera device. For example, in the 5-axis camera shake, there are two camera shakes that are shaken at an angle, two camera shakes that is shaken by a shift, and one camera shake that are shaken by rotation. At this time, only the 4-axis camera shake correction is possible with the lens shift method, and the camera shake that are shaken in rotation cannot be corrected. This is because the camera shake caused by rotation should be corrected by rotation of the optical module, and even when the lens module 1100 is rotated, an incident optical path is maintained as it is, and accordingly, the 5-axis camera shake correction is not possible with the lens shift method. Therefore, in the present embodiment, it is possible to solve a reliability problem of the lens shift method according to the development of the camera technology as described above, while applying the sensor shift method so as to enable the 5-axis camera shake correction.

[symbol]

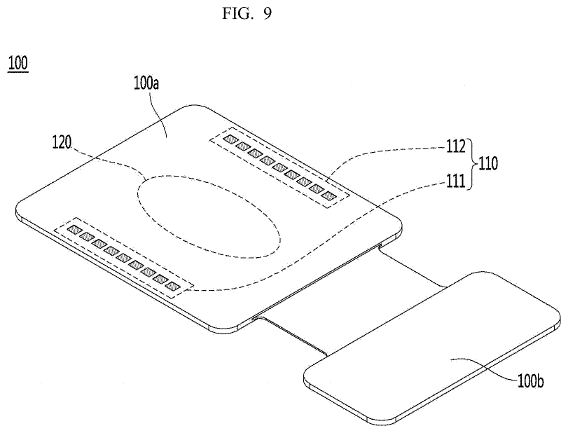

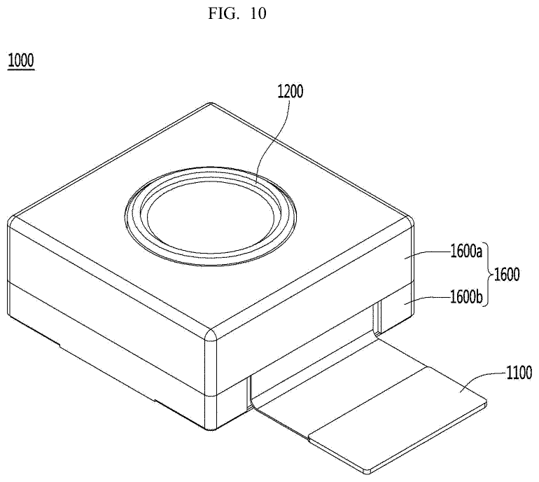

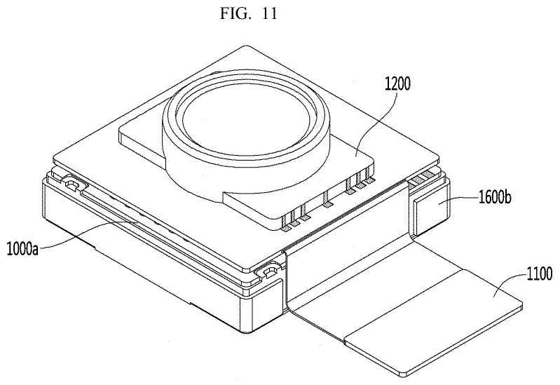

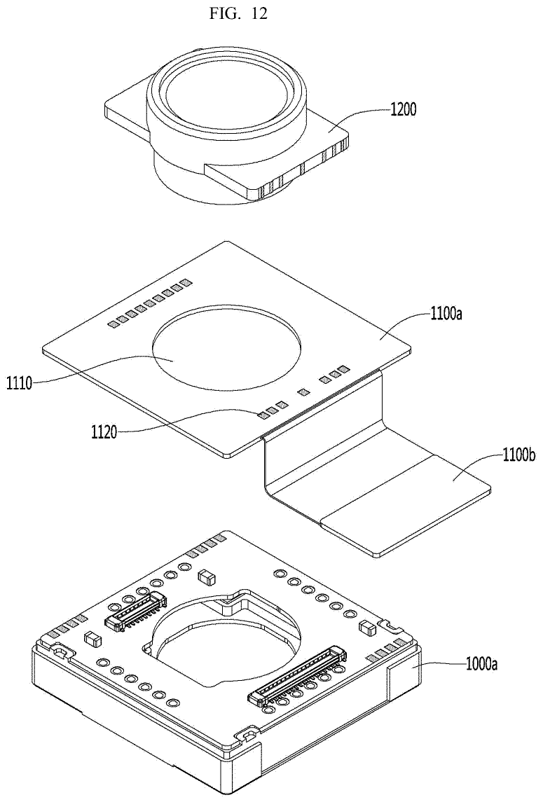

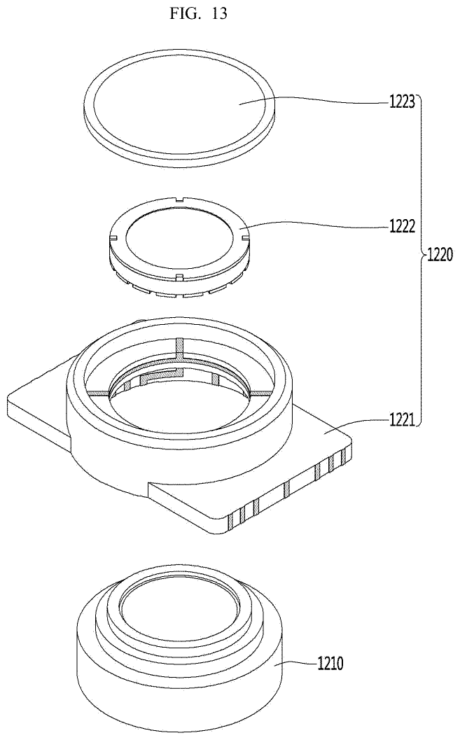

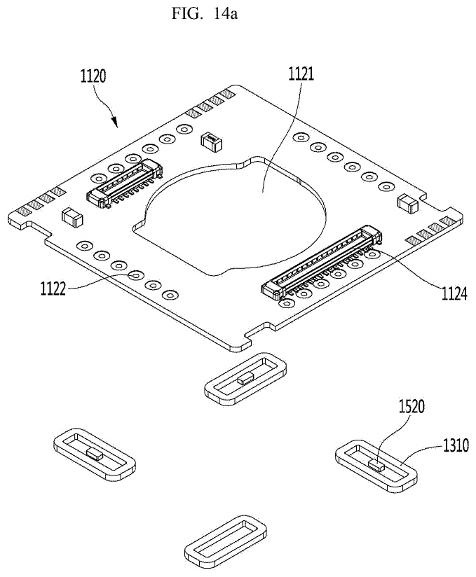

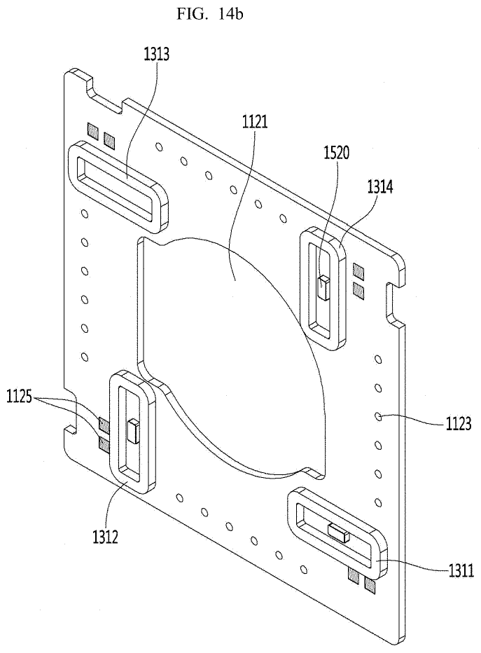

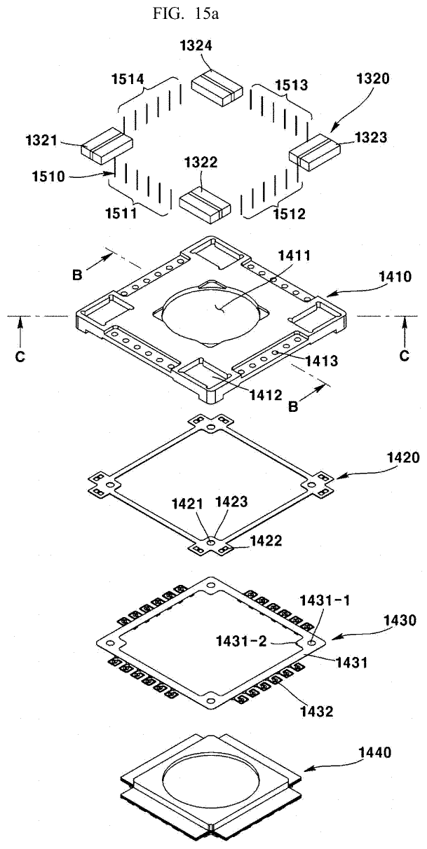

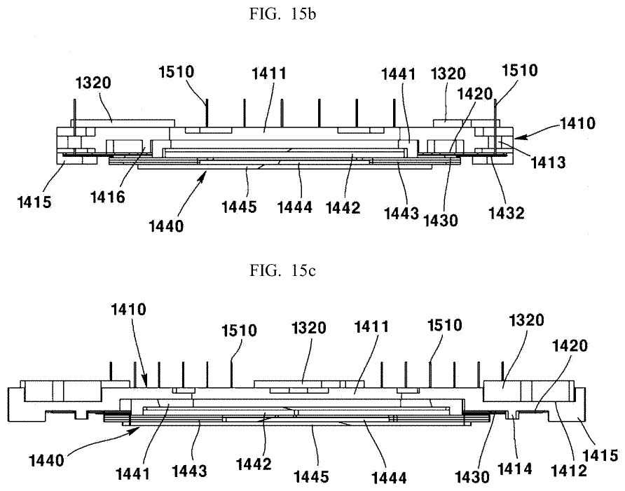

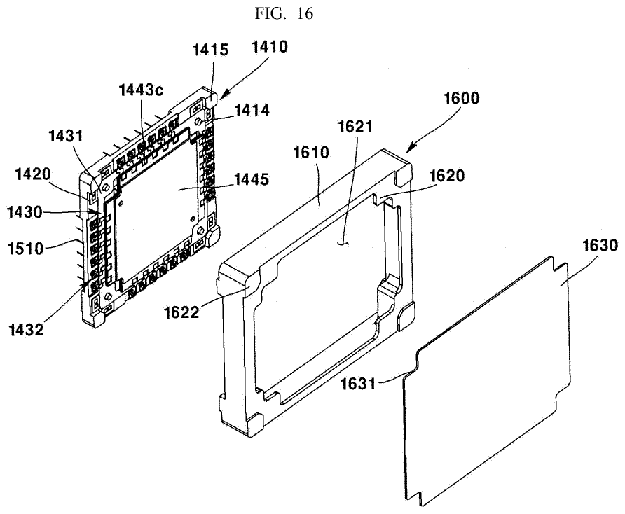

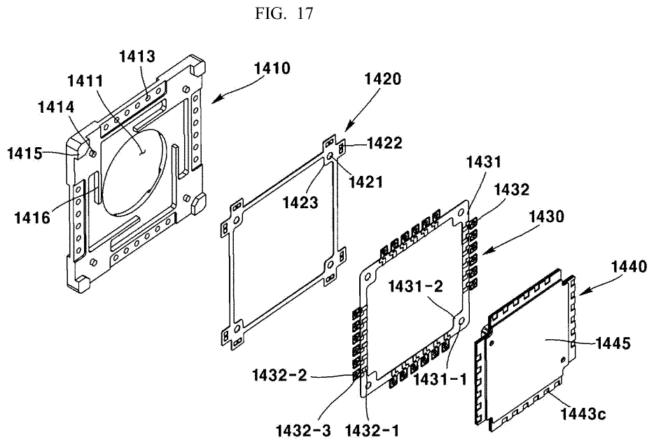

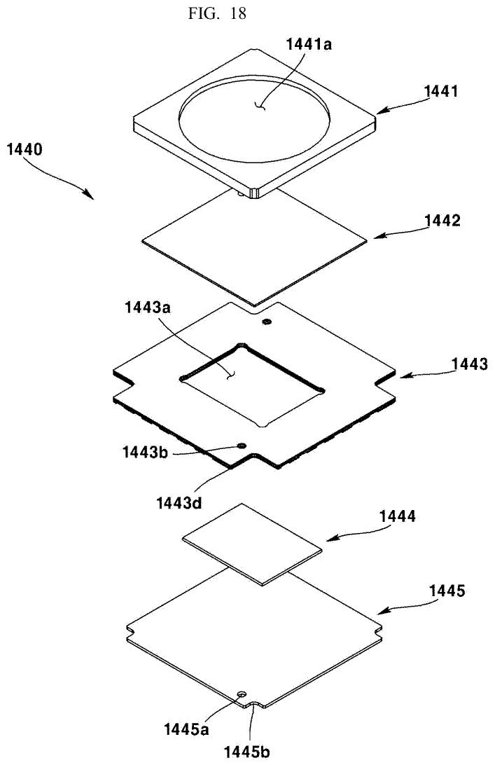

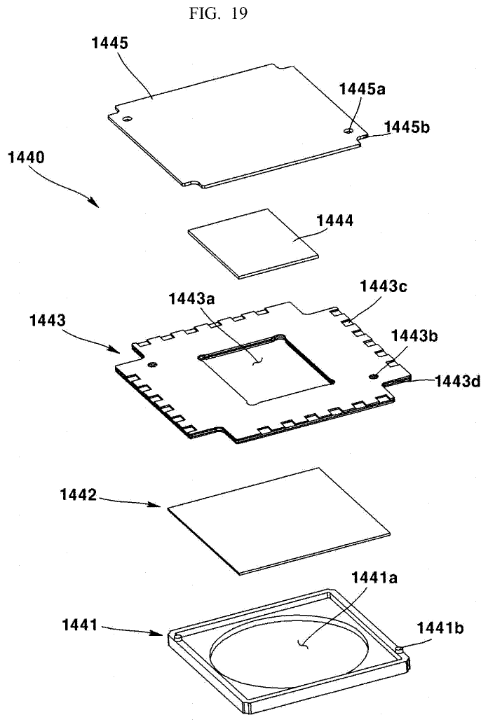

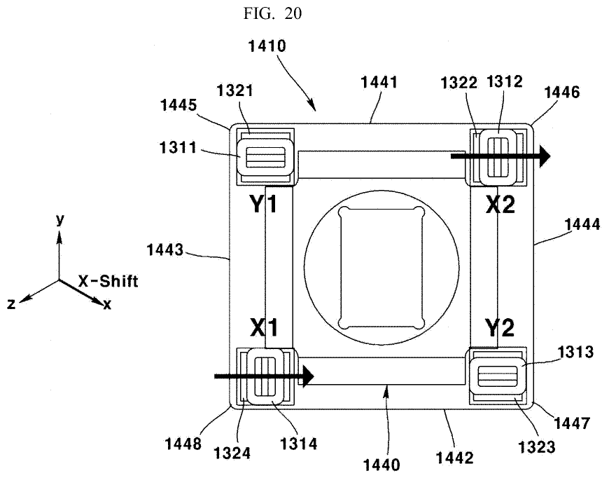

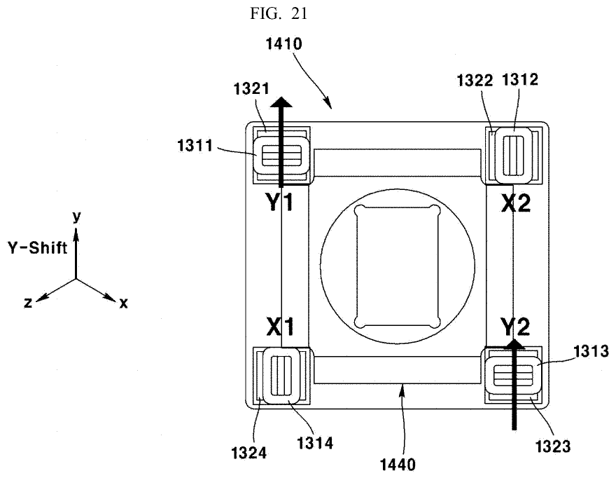

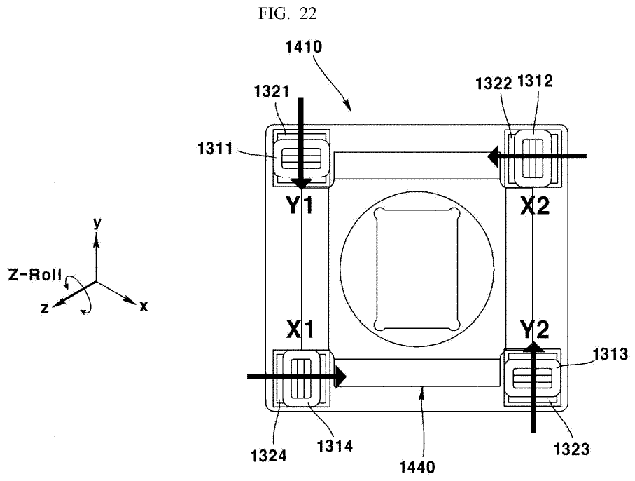

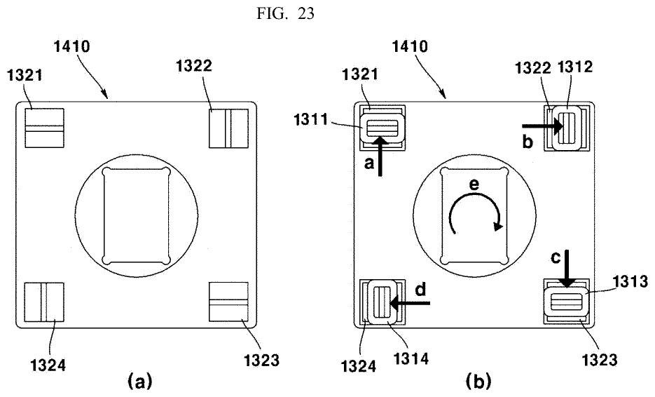

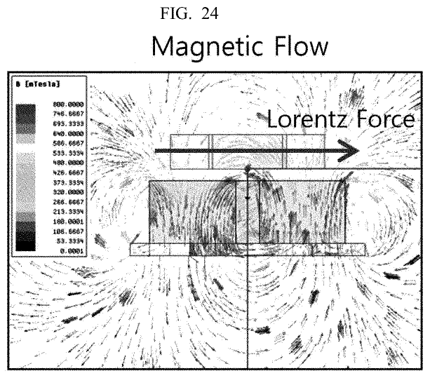

FIG. 10 is a perspective view of a camera device according to a second embodiment, FIG. 11 is a perspective view in a state in which the case shown in FIG. 10 is removed, FIG. 12 is an exploded perspective view of a partial configuration of the camera device of FIG. 11, FIG. 13 is an exploded perspective view of a lens module according to the second embodiment, FIG. 14a is an exploded perspective view of a partial configuration of the camera device according to the second embodiment, FIG. 14b is a bottom perspective view of a partial configuration of the camera device according to the second embodiment, FIG. 15a is an exploded perspective view of a partial configuration of the camera device according to the second embodiment, FIG. 15b is a cross-sectional view taken along line C-C of a state in which a partial configuration of the camera device of FIG. 15a are combined, FIG. 15c is a cross-sectional view taken along line D-D of a state in which a partial configuration of the camera device of FIG. 15a are combined, FIGS. 16 and 17 are exploded perspective views of a partial configuration of the camera device according to the second embodiment viewed from a direction different from that of FIG. 15A, FIG. 18 is an exploded perspective view of an image sensor module of the camera device according to the second embodiment, FIG. 19 is an exploded perspective view of the image sensor module of the camera device according to the second embodiment viewed from a different direction from that of FIG. 18, FIG. 20 is a view for explaining x-axis direction shift drive through a partial configuration of the camera device according to the second embodiment, FIG. 21 is a view for explaining y-axis direction shift drive through a partial configuration of the camera device according to the second embodiment, FIG. 22 is a view for explaining z-axis rotational drive through a partial configuration of the camera device according to the second embodiment, FIG. 23 (a) is a view showing magnets disposed on a base together with the x-axis and y-axis, FIG. 23 (b) is a view showing the base, the magnets and coils with the z-axis direction rotational drive, FIG. 24 is a dview showing a magnetic flow and a Lorentz force between a magnet and a coil of the camera device according to the second embodiment.

The camera device 1000 according to the second embodiment may include a camera module. The camera device 1000 may include a lens driving device. The lens driving device may be a variable focus lens 1222 including the lens module 1200 as described in the first embodiment. The variable focus lens 1222 may be an AF module for driving the lens.

The camera device 1000 may include an actuator 1000A. The actuator 1000A may drive the image sensor 1444. The actuator 1000A may tilt image sensor 1444. The actuator 1000A may move the image sensor 1444. The actuator 1000A may rotate the image sensor 1444. The actuator 1000A may move the image sensor 1444 in a first direction perpendicular to the optical axis, move the image sensor 1444 in a second direction perpendicular to the optical axis and the first direction, and rotate the image sensor 1444 based on the optical axis. In this case, the first direction may be the x-axis direction, the second direction may be the y-axis direction, and the optical axis may be the z-axis direction. The actuator 1000A may include a coil 1310 and a magnet 1320. The actuator may move the image sensor 1444 using electromagnetic force.

[symbol]

The camera device 1000 may include a first substrate 1100. The first substrate 1100 may be a main substrate. A part of the first substrate 1110 may be disposed inside the case 1600, and the remaining part may be exposed to the outside of the case 1600. The lens module 1200 may be disposed on the first substrate 1110. The actuator 1000A may be disposed under the first substrate 1110.

A lens module 1200 may be disposed on the first substrate 1100. In this case, the lens module 1200 may include a first lens portion 1210 and a second lens portion 1220 as described in the first embodiment.

At this time, since the first lens portion 1210 and the second lens portion 1220 have already been described in the first embodiment, a detailed description thereof will be omitted. However, the same reference numerals are given to the parts that are substantially the same as those of the first embodiment in the description of the second embodiment.

However, the second lens barrel 1221 constituting the second lens portion 1220 in the second embodiment has a portion corresponding to the first sidewall 441 and a portion corresponding to the extension portion 442 unlike in the first embodiment. Accordingly, the third lead pattern portion among the electrode patterns included in the second lens barrel 1221 according to the second embodiment may be disposed on the lower surface of the extension portion 442 differently from the first embodiment.

In addition, the third lead pattern portions disposed on the lower surface of the extension portion 442 of the second lens barrel 1221 may be electrically connected to the electrode 1120 formed on the first substrate 1100.

Meanwhile, the first region of the first lens barrel 1210 may be disposed inside the first sidewall 441 of the second lens barrel 1221 as described in the first embodiment. However, a part of the second region of the first lens barrel 1210 may be disposed in the open region 1110 of the first substrate 1100 disposed under the second lens barrel 1221, and the remaining part may be disposed in the open region of the actuator 1000A.

That is, a maximum width of the second lens barrel 1221 is greater than a maximum width of the first lens barrel 1210, and accordingly, the second lens barrel 1221 may accommodate at least a part of the first lens barrel 1210. In other words, an uppermost surface of the first lens barrel 1210 may be disposed in the second lens barrel 1221.

Also, the second lens barrel 1221 includes a protrusion 441a as described in the first embodiment. Preferably, the second lens barrel 1221 includes an inner periphery of a first region corresponding to the first sidewall 441 and a protrusion protruding inwardly from the inner periphery. And, the inner periphery of the protrusion has a formation corresponding to the outer surface of the variable focus lens 1222 included in the second lens portion 1220 as described in the first embodiment. That is, the outer surface of the variable focus lens 1222 is disposed to correspond to the inside of the protrusion, and thus may have a circular shape corresponding to each other. In addition, a diameter of an inner periphery of the first region of the second lens barrel 1221 may be greater than a diameter of an inner periphery of the protrusion 441a.

In conclusion, the lens module of the second embodiment is different from the first embodiment in the second lens barrel 1221 constituting the second lens portion.

The second lens barrel in the first embodiment is disposed to surround the entire outer surface of the first lens barrel, but the second lens barrel 1221 may be disposed to surround only the portion corresponding to the first region (the portion corresponding to 311 in the first embodiment) among the outer surface of the first lens barrel 1210, accordingly, a second region (a portion corresponding to 312 in the first embodiment) of the first lens barrel 1210 is exposed under the second lens barrel 1221, and disposed in the open region of the first substrate 1100 and the actuator 1000A.

The first substrate 1100 may include a first substrate region 1100a disposed in the case 1600 and a second substrate region 1100b exposed to the outside of the case 1600.

In addition, an open region 1110 in which the second region of the first lens barrel 1210 is disposed may be formed in the first substrate region 1100a.

Meanwhile, the case 1600 may include an upper case 1600a covering the first substrate 1100 and the lens module 1200, and a lower case 1600b covering the actuator 1000A.

The camera device 1000 may include a second substrate 1120. The second substrate 1120 may be disposed under the first substrate 1100. In this case, any one of the first substrate 1100 and the second substrate 1120 may be omitted. When any one of the first substrate 1100 and the second substrate 1120 is omitted, the function of the omitted substrate or a device disposed on the omitted substrate may be integrated into the non-omitted substrate.

The second substrate 1120 may be coupled to the wire 1510. The second substrate 1120 may be a rigid flexible PCB (RFPCB). The second substrate 1120 may include first to fourth corners.

The second substrate 1120 may include a first hole 1121. The first hole 1121 may be formed in a center of the second second substrate 1120.

The first hole 1121 may be a hollow hole. The first hole 1121 may be an opening. A part of the lens module 1200 may be disposed in the first hole 1121. Preferably, a part of the first lens portion 1210 constituting the lens module 1200 may be disposed in the first hole 1121. For example, the second region of the first lens barrel 1210 of the first lens portion 1210 may be disposed in the first hole 1121.

The second substrate 1120 may include a coupling portion 1122. The second substrate 1120 may be coupled to the wire 1510 at the coupling portion 1122. The second substrate 1120 and the wire 1510 may be coupled by soldering. The coupling portion 1122 may be a part in which a solder resistor is opened to be electrically connected to the wire 1510. A second hole 1123 may be formed in the coupling portion 1122. The second substrate 1120 may include a second hole 1123. The second hole 1123 may be a wire through hole passing through the wire 1510.

The second substrate 1120 may include a connector 1124. The connector 1124 may be electrically connected to the first substrate 1100. A connector corresponding to the connector 1124 of the second substrate 1120 may be disposed on the first substrate 1100.

The second substrate 1120 may include a terminal 1125. The terminal 1125 may be formed on a lower surface of the second substrate 1120. The terminal 1125 may be electrically connected to the coil 1310. The terminal 1125 may be coupled to a pair of lead wires of the coil 1310 by soldering or Ag epoxy. The terminal 1125 may include a plurality of terminals. The terminal 1125 may include a total of eight terminals as two are included in each of the four coils.

The camera device 1000 may include a coil 1310. The coil 1310 may be disposed on the second substrate 1120. The coil 1310 may be electrically connected to the second substrate 1120. The coil 1310 may be disposed to face the magnet 1320. When a current is applied to the coil 1310, an electric field may be formed around the coil 1310. When a current is applied to the coil 1310, one of the coil 1310 and the magnet 1320 may move relative to the other through electromagnetic interaction between the coil 1310 and the magnet 1320.

The coil 1310 may include four coils. In this case, current may be independently applied to at least three coils of the four coils. The coil 1310 in an embodiment may be controlled by three channels. Alternatively, the coil 1310 in an other embodiment may be controlled by four channels. The four coils 1310 may be electrically isolated from each other. Any one of a forward current and a reverse current may be selectively applied to each of the four coils 1310. In this embodiment, only three of the four coils may be electrically isolated and one coil may be electrically connected to the other coil. Alternatively, all four coils may be electrically isolated. When only three of the four coils are electrically isolated, a total of six lead wires of three pairs may come out from the coil 1310, and when all four coils are electrically isolated, a total of eight lead wires of four pairs may come out from the coil 1310.

When the four coils are controlled by three channels as in the embodiment of the present embodiment, a pair of the coil 1310 and the magnet 1320 should be driven in a z-axis-centered rotational drive, but when the four coils are controlled by four channels as in the other embodiment, two pair of the coil 1310 and the magnet 1320 may be driven in the z-axis-centered rotational drive.

The coil 1310 may include first to fourth coils 1311, 1312, 1313, and 1314. The first coil 1311 may be disposed to face a first magnet 1321. The second coil 1312 may be disposed to face a second magnet 1322. The third coil 1313 may be disposed to face a third magnet 1323. The fourth coil 1314 may be disposed to face a fourth magnet 1324. The first coil 1311 may be disposed in a first corner of the second substrate 1120. The second coil 1312 may be disposed in a second corner of the second substrate 1120. The third coil 1313 may be disposed in a third corner of the second substrate 1120. The fourth coil 1314 may be disposed in a fourth corner of the second substrate 1120. The first coil 1311 and the third coil 1313 may be disposed on a first diagonal direction of the second substrate 1120, and the second coil 1312 and the fourth coil 1314 may be disposed on a second diagonal direction of the second substrate 1120.

In the present embodiment, the first coil 1311 and the third coil 1313 may be disposed to be long in a first direction, and the second coil 1312 and the fourth coil 1314 may be disposed to be long in a second direction. In this case, the first direction and the second direction may be perpendicular. A long side of the first coil 1311 and a long side of the third coil 1313 may be disposed in parallel to each other. A long side of the second coil 1312 and a long side of the fourth coil 1314 may be disposed in parallel to each other. The long side of the first coil 1311 and the long side of the second coil 1312 may not be parallel to each other. In this case, the long side of the first coil 1311 and the long side of the second coil 1312 may be disposed such that virtual extension lines are orthogonal to each other. An arrangement direction of the first coil 1311 and an arrangement direction of the second coil 1312 may be orthogonal to each other.

In the present embodiment, a current may be independently applied to at least three coils among the first to fourth coils 1311, 1312, 1313, and 1314. The first to fourth coils 1311, 1312, 1313, and 1314 may be electrically isolated from each other.

The camera device 1000 may include the magnet 1320. The magnet 1320 may be disposed on the base 1410. The magnet 1320 may be disposed in a corner of the base 1410. The magnets 1320 may be disposed in four corners of the base 1410, respectively. The magnet 1320 may face the coil 1310. The magnet 1320 may electromagnetically interact with the coil 1310. The magnet 1320 may move by electromagnetic interaction with the coil 1310. That is, when a current is applied to the coil 1310, the magnet 1320 may move. The magnet 1320 may be a flat magnet having a flat plate shape. In the present embodiment, the coil 1310 may be fixed and the magnet 1320 may move. However, the arrangement positions of the coil 1310 and the magnet 1320 may be interchanged as a modified example.

The magnet 1320 may include a plurality of magnets. The magnet 1320 may include four magnets. The magnet 1320 may include first to fourth magnets 1321, 1322, 1323, and 1324. The first magnet 1321 may face the first coil 1311. The first magnet 1321 may be disposed in a first corner 1410e of the base 1410. The second magnet 1322 may face the second coil 1312. The second magnet 1322 may be disposed in a second corner 1410f of the base 1410. The third magnet 1323 may face the third coil 1313. The third magnet 1323 may be disposed in a third corner 1410g of the base 1410. The fourth magnet 1324 may face the fourth coil 1314. The fourth magnet 1324 may be disposed in a fourth corner 1410h of the base 1410. Each of the plurality of magnets may be disposed perpendicular to adjacent magnets and may be disposed in parallel with magnets disposed in a diagonal direction.

A polarity of a surface of the first magnet 1321 facing the coil 1310 may be different between a portion close to a first side surface and a portion close to a second side surface. A polarity of a surface of the second magnet 1322 facing the coil 1310 may be different between a portion close to a third side surface and a portion close to a fourth side surface. A polarity of a surface of the third magnet 1323 facing the coil 1310 may be different between a portion close to the first side surface and a portion close to the second side surface. A polarity of a surface of the fourth magnet 1324 facing the coil 1310 may be different between a portion close to the third side surface and a portion close to the fourth side surface. That is, the first magnet 1321 and the third magnet 1323 may be disposed in the same direction, and the second magnet 1322 and the fourth magnet 1324 may be disposed in the same direction. The first magnet 1321 may be disposed perpendicular to the second magnet 1322. Polarities of the first to fourth magnets 1321, 1322, 1323, and 1324 may be the same for inner portions. The polarities of the first to fourth magnets 1321, 1322, 1323, and 1324 may be the same for outer portions. Regarding the polarity of each of the first to fourth magnets 1321, 1322, 1323, and 1324, the inner portions may be formed as an N pole. Regarding the polarity of each of the first to fourth magnets 1321, 1322, 1323, and 1324, the outer portions may be formed as the S pole. However, as a modification, regarding the polarity of each of the first to fourth magnets 1321, 1322, 1323, and 1324, the inner portions may be formed as a S pole and the outer portions may be formed as the N pole.

As shown in FIG. 20, when currents in the same direction are applied to the second coil 1312 and the fourth coil 1314 in the present embodiment, the image sensor 1444 coupled to the base 1410 may be moved (shifted) in the x-axis direction by electromagnetic interaction between the second magnet 1322 and the fourth magnet 1324, respectively. That is, the second coil 1312, the second magnet 1322, and the fourth coil 1314 and the fourth magnet 1324 may be used for the x-axis direction shift drive of the image sensor 1444. In this case, the second coil 1312 and the second magnet 1322 may be a first x-axis shift driver X2, and the fourth coil 1314 and the fourth magnet 1324 may be a second x-axis shift driver X1.

As shown in FIG. 21, when currents in the same direction are applied to the first coil 1311 and the third coil 1313 in the present embodiment, the image sensor 1444 coupled to the base 1410 may be moved (shifted) in the y-axis direction by electromagnetic interaction between the first magnet 1321 and the third magnet 1323, respectively. That is, the first coil 1311, the first magnet 1321, the third coil 1313, and the third magnet 1323 may be used for the y-axis direction shift drive of the image sensor 1444. In this case, the first coil 1311 and the first magnet 1321 may be a first y-axis shift driver Y1, and the third coil 1313 and the third magnet 1323 may be a second y-axis shift driver Y2.

As shown in FIG. 22, currents in opposite directions are applied to the first coil 1311 and the third coil 1313 and currents in opposite directions are applied to the second coil 1312 and the fourth coil 1314 in the present embodiment, and at this time, when a direction in which the magnet 1320 is rotated by the current applied to the first coil 1311 and the current applied to the second coil 1312 is the same, the image sensor 1444 coupled to the base 1410 may be rotated (rolled) around the z-axis. An embodiment shown in FIG. 23 illustrates a case in which the coil 1310 is controlled by four channels, and when the coil 1310 is controlled by three channels, the image sensor 1444 may be rolled by the first coil 1311 and the third coil 1313 or the second coil 1312 and the fourth coil 1314. This is because when there is a coil bundled into one channel among the first coil 1311 and the third coil 1313, and the second coil 1312 and the fourth coil 1314, the current may not be applied in the opposite direction.

As shown in FIG. 23 (b), in the present embodiment, a forward current is applied to the first coil 1311, whereby the first coil 1311 pushes out the first magnet 1321 in the first direction (see FIG. 23 (a)), a forward current is applied to the second coil 1312, whereby the second coil 1312 pushes out the second magnet 1322 in the second direction (see FIG. 23 (b)), a reverse current is applied to the third coil 1313, whereby the third coil 1313 pushes out the third magnet 1323 in a third direction (see FIG. 23 (c)), and a reverse current is applied to the fourth coil 1314, whereby the fourth coil 1314 pushes out the fourth magnet 1324 in a fourth direction (see in FIG. 23 (d)), so that the image sensor 1444 coupled to the base 1410 may be rotated around the z-axis (see in FIG. 23 (e)). In this case, the first to fourth directions may correspond to a clockwise direction around the center of the base 1410.

In the present embodiment, a magnetic flow of the magnet 1320 is shown in FIG. 24. Referring to FIG. 24, it may be confirmed that lines of magnetic force passing perpendicular to the coil 1310 exists, and when a current is applied to the coil 1310 in this state, the coil 1310 may move with respect to the magnet 1320 by the Lorentz force.

The camera device 1000 may include a base 1410. The base 1410 may be spaced apart from the first substrate 1100 and the second substrate 1120. The base 1410 may be a mover which is a portion that moves together with the magnet 1320 when a current is applied to the coil 1310. In addition, the base 1410 may be a sensor PCB holder. The base 1410 may be shifted in the x-axis direction. The base 1410 may be shifted in the y-axis direction. The base 1410 may be rotated around the z-axis (optical axis).

The base 1410 may include a first hole 1411. The first hole 1411 may be a hollow hole. The first hole 1411 may be an opening.

The base 1410 may include a groove 1412. The groove 1412 may be formed on an upper surface of the base 1410. The groove 1412 may accommodate at least a part of the magnet 1320. The magnet 1320 may be disposed in the groove 1412 of the base 1410. The groove 1412 may be formed in a shape corresponding to the magnet 1320. However, a depth of the groove 1412 may be smaller than a thickness of the magnet 1320 in a corresponding direction. In this case, a part of the magnet 1320 disposed in the groove 1412 may protrude from the base 1410. The groove 1412 may include a plurality of grooves. The groove 1412 may be formed in a number corresponding to a number of the magnets 1320. The groove 1412 may include four grooves.

The base 1410 may include a second hole 1413 through which a wire passes. The second hole 1413 may be formed passing through the base 1410 in a direction parallel to the optical axis. The wire 1510 may be disposed into the second hole 1413. The wire 1510 may pass through the second hole 1413. The second hole 1413 may include a plurality of holes. The second hole 1413 may be formed in a number corresponding to a number of wires 1510. The second hole 1413 may include 24 holes.

The base 1410 may include a first protrusion 1414. The first protrusion 1414 may be formed on a lower surface of the base 1410. The first protrusion 1414 may be inserted into a first hole 1421 of a reinforcing member 1420 and a hole 1431-1 of a terminal portion 1430. The first protrusion 1414 may be formed in a shape corresponding to the first hole 1421 of the reinforcing member 1420 and the hole 1431-1 of the terminal portion 1430. The first protrusion 1414 may include a plurality of protrusions. The first protrusion 1414 may include four protrusions. The four protrusions may be formed at four corners of the base 1410, respectively.

The base 1410 may include a second protrusion 1415. The second protrusion 1415 may be formed on the lower surface of the base 1410. The second protrusion 1415 may be spaced apart from the first protrusion 1414. The second protrusion 1415 may extend from a side surface of the base 1410. A lower surface of the second protrusion 1415 may be disposed lower than a lower surface of the reinforcing plate 1445 of the image sensor module 1440. The second protrusion 1415 may include a plurality of protrusions. The second protrusion 1415 may include four protrusions. The four protrusions may be formed at four corners of the base 1410, respectively.

The base 1410 may include a guide protrusion 1416. The guide protrusion 1416 may be formed on the lower surface of the base 1410. The guide protrusion 1416 may guide an assembly position of the image sensor module 1440. The guide protrusion 1416 may contact a cover 1441 of the image sensor module 1440. The guide protrusion 1416 may contact four side surfaces of the cover 1441 of the image sensor module 1440.

The base 1410 may include a plurality of side surfaces. The base 1410 may include four side surfaces. The base 1410 may include first to fourth side surfaces 1410a, 410b, 410c, and 410d. The base 1410 may include the first side surface 1410a and the second side surface 1410b disposed opposite to each other, and the third side surface 1410c and the fourth side surface 1410d disposed opposite to each other between the first side surface 1410a and the second side surface 1410b.

The base 1410 may include a corner formed between the plurality of side surfaces. The base 1410 may include a plurality of corners. The base 1410 may include four corners. The base 1410 may include first to fourth corners 1410e, 1410f, 1410g, 1410h. The first corner 1410e of the base 1410 may be disposed between the first side surface 1410a and the third side surface 1410c. The second corner 1410f of the base 1410 may be disposed between the third side surface 1410c and the second side surface 1410b. The third corner 1410g of the base 1410 may be disposed between the second side surface 1410b and the fourth side surface 1410d. The fourth corner 1410h of the base 1410 may be disposed between the fourth side surface 1410d and the first side surface 1410a.

The camera device 1000 may include a reinforcing member 1420. The reinforcing member 1420 may be formed of stainless steel (SUS). The reinforcing member 1420 may reinforce the terminal portion 1430. The reinforcing member 1420 may be coupled to the terminal portion 1430. The reinforcing member 1420 may be adhered to the terminal portion 1430 by an adhesive. The reinforcing member 1420 may be disposed on the lower surface of the base 1410.

The reinforcing member 1420 may include the first hole 1421. The first hole 1421 may be coupled to the first protrusion 1414 of the base 1410. The reinforcing member 1420 may include a second hole 1422. An adhesive may be applied to the second hole 1422. The second hole 1422 may be formed in a protruding portion of the reinforcing member 1420. The second hole 1422 may include a plurality of holes. The second holes 1422 may be formed in a total of 16, two for each of eight protruding portions, two for each of four corners of the reinforcing member 1420.

The reinforcing member 1420 may include a protruding part 1423. The protruding part 1423 may be formed protruding inward from a corner of the reinforcing member 1420. A space in which the first hole 1421 is to be formed may be secured in the reinforcing member 1420 by the protruding part 1423. The first hole 1421 may be formed in the protruding part 1423.

The camera device 1000 may include the terminal portion 1430. The terminal portion 1430 may be disposed on the lower surface of the base 1410. The terminal portion 1430 may be coupled to the reinforcing member 1420. The terminal portion 1430 may be coupled to the image sensor module 1440.

The terminal portion 1430 may include an substrate 1431. The substrate 1431 may be coupled to the lower surface of the base 1410. The substrate 1431 may be coupled to the reinforcing member 1420. The substrate 1431 may be coupled to the image sensor module 1440. The substrate 1431 may include a hole 1431-1. The hole 1431-1 may be coupled to the first protrusion 1414 of the base 1410. The substrate 1431 may include a protruding part 1431-2. The protruding part 1431-2 may be formed protruding inward from a corner of the substrate 1431. A space in which the hole 1431-1 is formed may be secured by the protruding part 1431-2. The hole 1431-1 may be formed in the protruding part 1431-2.

The terminal portion 1430 may include a terminal 1432. The terminal 1432 may be electrically connected to a terminal of the image sensor 1444. The terminal 1432 may include a plurality of terminals. The terminal 1432 may include a total of 24 terminals.

The terminal 1432 includes a first coupling part 1432-1 disposed on the substrate 1431, a second coupling part 1432-2 coupled to the wire 1510, and a connection part 1432-3 connecting the first coupling part 1432-1 and the second coupling part 1432-2. A hole through which the wire 1510 passes may be formed in the second coupling part 1432-2. The second coupling part 1432-2 may be coupled to the wire 1510 by soldering. The connection part 1432-3 may include a bent portion. The connection part 1432-3 may be bent a plurality of times. The connection part 1432-3 may have elasticity. The terminal 1432 may have elasticity.

Meanwhile, the camera device 1000 may include the image sensor module 1440. The image sensor module 1440 may be coupled to the base 1410. The image sensor module 1440 may be fixed to the base 1410. The image sensor module 1440 may move integrally with the base 1410. The image sensor module 1440 may include the cover 1441, a filter 1442, a third substrate 1443, the image sensor 1444, and the reinforcing plate 1445. However, any one or more of the cover 1441, the filter 1442, the third substrate 1443, the image sensor 1444, and the reinforcing plate 1445 of the image sensor module 1440 may be omitted.

The image sensor module 1440 may include the cover 1441. The cover 1441 may cover the filter 1442 and the image sensor 1444. The cover 1441 may include an upper plate part and a side wall part. The cover 1441 may include a hole 1441a. The hole 1441a may be a hollow hole. The hole 1441a may be an opening. The cover 1441 may include a protrusion 1441b. The protrusion 1441b may protrude from a lower surface of the cover 1441. The protrusion 1441b may be inserted into a second hole 1443b of the third substrate 1443 and a hole 1445a of the reinforcing plate 1445.

The image sensor module 1440 may include the filter 1442. The filter 1442 may serve to block light having a specific frequency band of light passing through the lens module 1200 from being incident on the image sensor 1444. The filter 1442 may be disposed to be parallel to an x-y plane. The filter 1442 may be disposed between the lens module 1200 and the image sensor 1444. The filter 1442 may be disposed between the cover 1441 and the third substrate 1443. As a modified example, the filter 1442 may be disposed in the hole 1441a of the cover 1441. The filter 1442 may include an infrared filter. The infrared filter may absorb or reflect infrared light incident on the infrared filter.

The image sensor module 1440 may include the third substrate 1443. The third substrate 1443 may be an ‘image sensor substrate’ on which the image sensor 444. The third substrate 1443 may include a printed circuit board (PCB). The third substrate 1443 may include a circuit board. The image sensor 1444 may be disposed on the third substrate 1443. The third substrate 1443 may be coupled to the terminal portion 1430. The third substrate 1443 may include a first hole 1443a having a shape and a size corresponding to the image sensor 1444. The image sensor 1444 may be inserted into the first hole 1443a of the third substrate 1443. The third substrate 1443 may include the second hole 1443b. The protrusion 1441b of the cover 1441 may be inserted into the second hole 1443b of the third substrate 1443. The third substrate 1443 may include a terminal 1443c. The terminal 1443c of the third substrate 1443 may be disposed at each of four side ends of the third substrate 1443. The terminal 1443c of the third substrate 1443 may be connected to the terminal 1432 of the terminal portion 1430. The third substrate 1443 may include a groove 1443d. The groove 1443d of the third substrate 1443 may be formed at each of four corners of the third substrate 1443. The first protrusion 1414 of the base 1410 may be avoided by the groove 1443d of the third substrate 1443.

The image sensor module 1440 may include the image sensor 1444. The image sensor 1444 may be coupled to the base 1410. The image sensor 1444 may move integrally with the base 1410. However, the third substrate 1443 to which the image sensor 1444 is coupled may be coupled to the base 1410 without the image sensor 1444 being directly coupled to the base 1410. As a modified example, the image sensor 1444 may be directly coupled to the base 1410. The image sensor 1444 may be disposed to be aligned with the optical module. The image sensor 1444 may be a configuration in which light passing through the lens and the filter 1442 is incident to form an image. The image sensor 1444 may be mounted on the third substrate 1443. The image sensor 1444 may be electrically connected to the third substrate 1443. As an example, the image sensor 1444 may be coupled to the third substrate 1443 by surface mounting technology (SMT). As another example, the image sensor 1444 may be coupled to the substrate 443 by flip chip technology. The image sensor 1444 may be disposed such that the optical axis coincides with the lens. That is, the optical axis of the image sensor 1444 and the optical axis of the lens may be aligned. The image sensor 1444 may convert light irradiated to an effective image region of the image sensor 1444 into an electrical signal. The image sensor 1444 may be any one of a charge coupled device (CCD), a metal oxide semi-conductor (MOS), a CPD, and a CID.

In the present embodiment, the image sensor 1444 may be rotated around the x-axis, the y-axis, and the z-axis. The image sensor 1444 may move around the x-axis, the y-axis, and the z-axis. The image sensor 1444 may be tilted around the x-axis, the y-axis, and the z-axis.

The image sensor module 1440 may include the reinforcing plate 1445. The reinforcing plate 1445 may be disposed on the lower surface of the image sensor 1444 and the third substrate 1443. The reinforcing plate 1445 may be formed of stainless steel (SUS). The reinforcing plate 1445 may reinforce the image sensor 1444 and the third substrate 1443. The reinforcing plate 1445 may include the hole 1445a. The hole 1445a may be coupled to the protrusion 1441b of the cover 1441. The reinforcing plate 1445 may include a groove 1445b. The groove 1445b may be formed at each of four corners of the reinforcing plate 1445. The groove 1445b may be formed such that a corner of the reinforcing plate 1445 is recessed inward.

The camera device 1000 may include the wire 1510. The wire 1510 may connect the second substrate 1120 and the terminal portion 1430. The wire 1510 may have elasticity. The wire 1510 may be an elastic member. The wire 1510 may be a wire spring. The wire 1510 may be formed of metal. The wire 1510 may be electrically connected to the image sensor 1444. The wire 1510 may be used as a conductive line of the image sensor 1444. One end of the wire 1510 may be coupled to the second substrate 1120, and the other end of the wire 1510 may be coupled to the terminal 1432. The wire 1510 may elastically support movement of the base 1410.

The wire 1510 may include a plurality of wires. The plurality of wires may include a number of wires corresponding to a number of terminals of the image sensor 1444. The plurality of wires may include a total of 24 wires, six for each between adjacent corners of four corners of the substrate holder.

The camera device 1000 may include a sensor 1520. The sensor 1520 may be disposed on an upper surface of the second substrate 1120. The sensor 1520 may include a hall sensor (Hall IC). The sensor 1520 may sense the magnetic force of the magnet 1320. Movement of the image sensor 1444 may be grasped in real time via the magnetic force of the magnet 1320 sensed by the sensor 1520. Through this, OIS feedback control may be possible.

The sensor 1520 may include a plurality of sensors. The sensor 1520 may include three sensors. Through the three sensors, an x-axis movement, a y-axis movement, and a z-axis-centered rotation of the image sensor 1444 may be sensed. The sensor 1520 may include first to third sensors. The first sensor may face the first magnet 1321, the second sensor may face the second magnet 1322, and the third sensor may face the third magnet 1323.

The camera device 1000 may include a first substrate 1100, and the first substrate 1100 may be electrically connected to the coil 1310. The first substrate 1100 may include a terminal 1120 coupled to the electrode pattern formed on the second lens barrel 1221. In addition, a connector (not shown) may be included in the second substrate region 1100b of the first substrate 1100. The connector may be electrically connected to the first substrate 1100. The connector may include a port for electrically connecting to an external device.

The camera device 1000 may include a motion sensor. The motion sensor may be mounted on the first substrate 1100. The motion sensor may be electrically connected to a controller through a circuit pattern provided on the first substrate 1100. The motion sensor may output information of a rotational angular velocity due to the movement of the camera device 1000. The motion sensor may include at least one of a two-axis gyro sensor, a three-axis gyro sensor, and an angular velocity sensor.

The camera device 1000 may include the controller. The controller may be disposed on the first substrate 1100. The controller may be electrically connected to the coil 1310. The controller may individually control a direction, intensity, and amplitude of a current supplied to the first to fourth coils 1311, 1312, 1313, and 1314. The controller may control a current applied to the coil 1310 and a current applied to the variable focus lens 1222 to perform the auto focus function and/or the camera shake correction function. Further, the controller may perform auto focus feedback control and/or camera shake correction feedback control.

The camera device 1000 according to the present embodiment may be for mobile camera application. That is, it may be distinguished from a camera device for digital camera application. When down-sizing for mobile camera application, a driving force of VCM is relatively lowered, and thus there is a problem that a current consumed in order to implement three operations (X-Shift, Y-Shift, Z-Rotation (Roll)) is increased.

The magnet 1320 and the coil 1310 are rotated 90 degrees at each corner of the base 1410, so that the magnet 1320 and the coil 1310 positioned at diagonal angles may be assembled in the same direction. In this case, a Lorentz force in the same direction may be generated when the image sensor 1444 is shift driven, and two pairs of torque may be generated by a force in an opposite direction during a z-axis rotational drive.

In the present embodiment, since four coils located at the corners require current inputs that are independent of each other, it is possible to have a system in which a power terminal of the coil 1310 is separated to control by four channels. That is, the present embodiment may include a magnet diagonal arrangement structure in the same magnetic flux direction and an individual current input structure of four coils.

The present embodiment may include two pairs of torque generating structures (increasing in rotation moment). It is possible to generate rotation moment higher than the conventional one by the structures that generate the two pairs of torque, and to reduce total current consumption when driving three modes of X-Shift, Y-Shift, and Z-Rotation (Roll).

Simulation results of the camera device according to the present embodiment are as follows. When “rotation moment=rotational torque*distance between torques=(electromagnetic force*input current)*distance between centers of magnets 1320”, and 50 mA as an input current is applied to the coil 1310 of the camera device 1000 according to the present embodiment, it was confirmed that a rotational moment of {(0.094 mN/mA×50 mA)×12.14 mm}×2=114.1 mN·mm was generated.

In the present embodiment, a camera shake correction for the lens corresponding to a camera shake correction for the image sensor 1444 may be performed together. For example, when the camera shake correction is performed only by the variable focus lens 1222, positive distortion may occur at an edge of an image obtained by the image sensor 1444. Meanwhile, when the camera shake correction is performed by moving only the image sensor 1444, negative distortion may occur at the edge of the image obtained by the image sensor 1444. In the present embodiment, the camera shake correction of the image sensor 1444 and the camera shake correction of the variable focus lens 1222 may be performed together to minimize distortion generated at the edge of the image. In the present embodiment, it is possible to perform the camera shake correction function at the lens side through the variable focus lens 1222, and move so as to correspond to the image sensor 1444. Through this, it is possible to provide a camera shake correction of a level corresponding to the module moving method which is a method of integrally moving the lens and the image sensor 1444. However, the variable focus lens 1222 according to the present embodiment may provide only the AF function and perform an OIS function by moving the image sensor 1444.

[symbol]

Hereinafter, an optical device according to the present embodiment will be described with reference to the drawings.

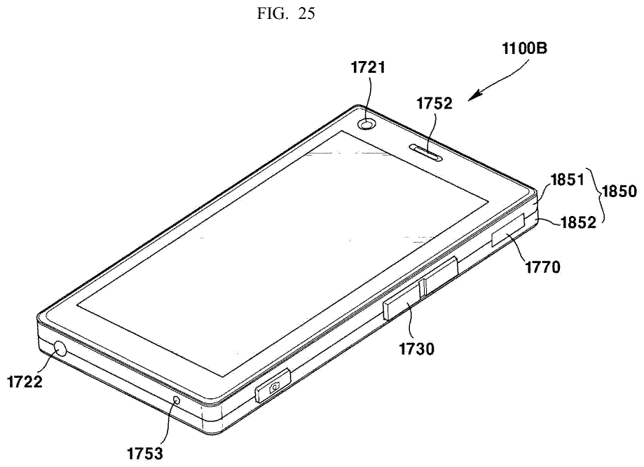

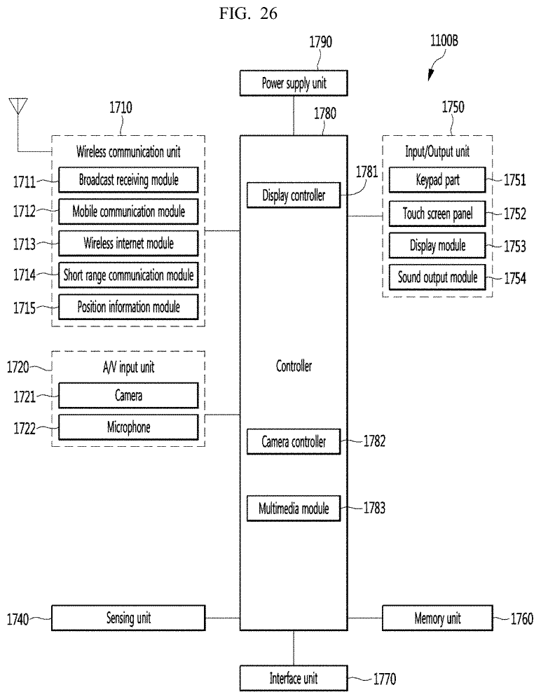

FIG. 25 is a perspective view of an optical device according to the present embodiment, and FIG. 26 is a block diagram of the optical device shown in FIG. 25.

The optical device 1000B may be any one of a mobile phone and a portable phone, a smart phone, a portable smart device, a digital camera, a laptop computer, a digital broadcasting terminal, a personal digital assistant (PDA), a portable multimedia player (PMP), and a navigation device. However, types of the optical device 1000B are not limited thereto, and any device for capturing an image or a picture may be included in the optical device 1000B.

The optical device 1000B may include a main body 1850. The main body 1850 may be in the form of a bar. Alternatively, the main body 1850 may have various structures such as a slide type, a folder type, a swing type, a swivel type, and the like in which two or more sub-bodies are coupled to be relatively movable. The main body 1850 may include a case (casing, housing, and cover) forming an external appearance. For example, the main body 1850 may include a front case 1851 and a rear case 1852. Various electronic components of the optical device 1000B may be built in a space formed between the front case 1851 and the rear case 1852. A display 1751 may be disposed on one surface of the main body 1850. A camera 1721 may be disposed on any one or more surfaces of one surface of the main body 1850 and the other surface disposed on the opposite side of the one surface.

The optical device 1000B may include a wireless communication unit 1710. The wireless communication unit 1710 may include one or more modules that enable wireless communication between the optical device 1000B and a wireless communication system or between the optical device 1000B and a network in which the optical device 1000B is positioned. For example, the wireless communication unit 1710 may include any one or more of a broadcast receiving module 1711, a mobile communication module 1712, a wireless internet module 1713, a short range communication module 1714, and a position information module 1715.

The optical device 1000B may include an A/V input unit 1720. The A/V input unit 1720 is for inputting an audio signal or a video signal and may include any one or more of a camera 1721 and a microphone 1722. In this case, the camera 1721 may include a camera device 10, 1000 according to the embodiment described above.

The optical device 1000B may include a sensing unit 1740. The sensing unit 1740 may sense a current state of the optical device 1000B such as an opening/closing state of the optical device 1000B, a position of the optical device 1000B, a presence of a user contact, orientation of the optical device 1000B, acceleration/deceleration of the optical device 1000B, and the like to generate a sensing signal for controlling an operation of the optical device 1000B. For example, when the optical device 1000B is in the form of a slide phone, whether the slide phone is opened or closed may be sensed. In addition, it may be responsible for sensing functions related to whether a power supply unit 1790 supplies power or whether an interface unit 1770 is coupled to an external device.

The optical device 1000B may include an input/output unit 1750. The input/output unit 1750 may be a configuration for generating an input or output related to vision, hearing, or tactile sense. The input/output unit 1750 may generate input data for controlling an operation of the optical device 1000B, and may output information processed by the optical device 1000B.

The input/output unit 1750 may include at least one of a keypad portion 1730, a display 1751, a sound output module 1752, and a touch screen panel 1753. The keypad portion 1730 may generate input data by using a keypad input. The display 1751 may output an image captured by the camera 1721. The display 1751 may include a plurality of pixels whose color changes according to an electrical signal. For example, the display 1751 may include at least one of a liquid crystal display (LCD), a thin film transistor-liquid crystal display (TFT LCD), an organic light-emitting diode (OLED), a flexible display, and a three-dimensional (3D) display. The sound output module 1752 may output audio data received from the wireless communication unit 1710 in a call signal reception, a call mode, a recording mode, a voice recognition mode, or a broadcast reception mode, or output audio data stored in a memory unit 1760. The touch screen panel 1753 may convert a change in capacitance generated due to a user's touch on a specific region of a touch screen into an electrical input signal.

The optical device 1000B may include the memory unit 1760. The memory unit 1760 may store a program for processing and controlling a controller 1780. In addition, the memory unit 1760 may store input/output data, for example, any one or more of a phone book, a message, audio, a still image, a photo, and a video. The memory unit 760 may store an image captured by the camera 1721, for example, a picture or a video.

The optical device 1000B may include the interface unit 1770. The interface unit 1770 serves as a path for connecting with an external device connected to the optical device 1000B. The interface unit 1770 may receive data from an external device, receive power to transfer to each element inside the optical device 1000B, or transmit data within the optical device 1000B to an external device. The interface unit 1770 may include any one or more of a wired/wireless headset port, an external charger port, a wired/wireless data port, a memory card port, a port connecting a device equipped with an identification module, and audio input/output (I/O) port, a video input/output (I/O) port, and an earphone port.

The optical device may include the controller 1780. The controller 1780 may control an overall operation of the optical device 1000B. The controller 1780 may perform related control and processing for voice call, data communication, video call, and the like. The controller 1780 may include a multimedia module 1781 for playing multimedia. The multimedia module 1781 may be provided in the controller 1780, or may be provided separately from the controller 1780. The controller 1780 may perform a pattern recognition processing for recognizing a writing input or a drawing input performed on a touch screen as text and an image, respectively.

The optical device 1000B may include the power supply unit 1790. The power supply unit 1790 may receive an external power source or an internal power source by a control of the controller 1780 to supply the power necessary for operating each element.

A lens module according to the present embodiment includes a first lens barrel in which a first solid lens is disposed; and a second lens barrel disposed on the first lens barrel and in which a variable focus lens is disposed. In this case, the second lens barrel includes a protrusion corresponding to a side surface of the variable focus lens, and a shape of the variable focus lens viewed from the optical axis has a circular shape, and an inner periphery of the protrusion has a circular shape corresponding to the shape of the variable focus lens. In addition, a second solid lens as well as the variable focus lens may be additionally disposed in the second lens barrel. According to this, the plurality of solid lenses and the variable focus lens in the embodiment are combined by applying two lens barrels while the variable focus lens and the solid lens are combined and disposed in one second lens barrel, and accordingly, the structure of the lens module can be simplified to improve assembly, and thereby, the overall size of the lens module can be reduced.

In addition, an electrode pattern electrically connected to the variable focus lens in the lens module according to the present embodiment is disposed on an inner periphery of the second lens barrel. Accordingly, an additional structure for disposing the electrode pattern may be removed by disposing an electrode pattern for controlling the variable focus lens in the lens barrel. In addition, a control signal in an embodiment may be transmitted to the variable focus lens through a shortest path, or state information of the variable focus lens may be obtained, and accordingly, the variable focus lens can be controlled in a more accurate state, and accordingly, operation reliability may be improved.

Although the embodiments of the present invention have been described with reference to the accompanying drawings, those skilled in the art to which the present invention pertains will be understood that the present invention may be implemented in other specific forms without modifying the technical spirit and essential features of the present invention. Therefore, it should be understood that the embodiments described above are illustrative in all aspects and not restrictive.

1. A lens module comprising:
a first lens barrel in which a first solid lens is disposed;
a second lens barrel disposed on the first lens barrel; and
a variable focus lens disposed in the second lens barrel;
wherein at least a part of the first lens barrel is disposed in the second lens barrel, and
wherein the at least a part of the first lens barrel includes a region spaced apart from an inner surface of the second lens barrel.

2. The lens module of claim 1, comprising:
a second solid lens disposed in the second lens barrel,
wherein the variable focus lens is disposed between the first solid lens and the second solid lens.

3. The lens module of claim 1, wherein the second lens barrel includes a protrusion corresponding to a side surface of the variable focus lens.

4. The lens module of claim 3, wherein a shape of the variable focus lens viewed in an optical axis direction has a circular shape.

5. The lens module of claim 4, wherein the protrusion is formed along the side surface of the variable focus lens, and
wherein an inner periphery of the protrusion has a circular shape.

6. The lens module of claim 1, wherein the second lens barrel includes:
a first region including a first sidewall; and
an extension portion extending outwardly from the first sidewall.

7. The lens module of claim 6, wherein the second lens barrel includes a second region including a second sidewall extending downwardly from the extension portion.

8. The lens module of claim 1, wherein the first lens barrel includes a first region having a first width and a second region having a second width greater than the first width.

9. The lens module of claim 8, wherein an outer side of the first lens barrel has a stepped portion.

10. The lens module of claim 6, wherein the first sidewall of the second lens barrel overlaps the first region of the first lens barrel in a direction parallel to an optical axis.

11. The lens module of claim 3, wherein the second lens barrel includes an electrode pattern electrically connected to the variable focus lens.

12. The lens module of claim 11, wherein the electrode pattern includes electrode lines equal to or greater than a number of electrodes of the variable focus lens.

13. The lens module of claim 11, wherein at least a part of the electrode pattern is disposed between the protrusion and a lower surface of the second lens barrel.

14. The lens module of claim 13, wherein the electrode pattern includes a plurality of electrode lines, and
wherein a shape formed by one ends of the plurality of electrode lines is a circular shape.

15. The lens module of claim 7, wherein the second region of the second lens barrel has a shape in which one side is open.

16. A lens module comprising:
a substrate portion;
a second lens barrel disposed on the substrate portion;
a first lens barrel including at least a part disposed in the second lens barrel;
a variable focus lens disposed in the second lens barrel; and,
a first solid lens disposed in the first lens barrel;
wherein the at least part of the first lens barrel includes a region spaced apart from an inner surface of the second lens barrel, and
wherein the second lens barrel includes an electrode pattern electrically connected to the variable focus lens and the substrate portion.

17. The lens module of claim 16, wherein the substrate portion includes a first substrate, and
wherein the first substrate has an opening in which a part of the first lens barrel is disposed.

18. A lens module comprising:
a first lens barrel in which a first solid lens is disposed; and
a second lens barrel including a first region in which a variable focus lens is disposed;
wherein at least a part of the first lens barrel is disposed in the second lens barrel,
wherein an inner periphery of the first region and an outer periphery of the variable focus lens have a circular shape, and
wherein a maximum width of the second lens barrel is greater than a maximum width of the first lens barrel.

19. The lens module of claim 18, wherein an uppermost surface of the first lens barrel is disposed in the second lens barrel.

20. The lens module of claim 18, wherein the first region has a protrusion protruding inwardly from the inner periphery,
wherein an outer surface of the variable focus lens is disposed to correspond to an inner periphery of the protrusion, and
wherein a diameter of the inner periphery of the protrusion is smaller than a diameter of the inner periphery of the first region.
